(19) United States
(12) Patent Application Publication
(10) Pub. No.: US 2022/0182502 A1
(43) Pub. Date: Jun. 9, 2022

(54) Converter, Media Detecting System, Image Forming Apparatus, And Computer-Readable Recording Medium Storing Control Program

(71) Applicant: Konica Minolta, Inc., Tokyo (JP)

(72) Inventor: Hiroyuki MARUYAMA, Toyokawa-shi (JP)

(73) Assignee: Konica Minolta, Inc., Tokyo (JP)

(21) Appl. No.: 17/539,734

(22) Filed: Dec. 1, 2021

(30) Foreign Application Priority Data
Dec. 4, 2020 (JP) 2020-201935

(51) Int. Cl. H04N 1/00

(52) U.S. Cl. CPC H04N 1/00726; H04N 1/00779

(57) ABSTRACT

A converting device includes an acquisitor that acquires, from a first media sensor, first detection data constituted by a measurement result of one or more paper physical properties obtained by measuring a recording medium, a converter that converts the acquired first detection data into conversion data being information on a basis of a measurement result of a second media sensor; and an output unit that outputs conversion data converted by the converter.

### CROSS-REFERENCE TO RELATED APPLICATION

The entire disclosure of Japanese patent application No. 2020-201935, filed on Dec. 4, 2020, is incorporated herein by reference in its entirety.

### BACKGROUND

### 1. Technical Field

The present invention relates to a converter, a media detecting system, an image forming apparatus, and a computer-readable recording medium storing a control program.

### 2. Description of Related Arts

In recent years, in color printing industries, image forming apparatuses, such as a printer of an electro-photographing method, have been utilized widely. In the field of PP (Production Print) dealing with color printing industries, as compared with a case where the PP is used in an office, adaptation to various types of papers is requested (herein, in this specification, “a paper” means “a sheet of paper” or “a sheet-shaped paper”). Furthermore, in order to perform printing with high quality to these various types of papers, there is an image forming apparatus that sets a plurality of items as the characteristics of a paper stored in a paper feed tray and performs printing on an image formation condition corresponding to the set items.

Conventionally, paper information such as the paper type and basic weight of a paper to be used has been input by a user from an operation panel with reference to information indicated on a package of papers. An image forming apparatus performs printing on the image formation condition set on the basis of this input paper information.

On the other hand, in order to save time and labor for inputting such paper information or to acquire more detailed information, there is technology to detect a surface nature and a basic weight with an external or built-in media sensor (for example, refer to Patent Literature 1 (Japanese Unexamined Patent Publication No. 2015-125237) and Patent Literature 2 (Japanese Unexamined Patent Publication No. 2009-029622).

### SUMMARY

On an image forming apparatus side, in order to acquire detailed information on a paper, a number of items of paper physical properties to be measured by a media sensor is increased or a sensor is replaced with one whose accuracy of measurement has been improved. Accordingly, as compared with a media sensor of an old generation, the performance of a media sensor of the newest type has got improved. In an image forming apparatus, in the case where the detection data of a built-in media sensor is used in the apparatus itself, it does not cause a problem. However, in the case where an external media sensor is used or in the case where the detection data of a built-in media sensor of other image forming apparatuses is used in another image forming apparatus, unless media sensors have the same function with each other, there is a problem that the detection data cannot not be used correctly.

The present invention has been achieved in view of the above-mentioned circumstances, and an object of the present invention is to provide a converter in which, even in a case where respective functions or performances are different between media sensors of different generations or different types, detection data of them are enabled to be used correctly.

In order to realize the above-described object, a converting device, which reflects one aspect of the present invention, for use in a media detecting system that includes a first media sensor that includes one or more internal sensors and measures one or more paper physical properties of a recording medium and a second media sensor that includes one or more internal sensors and measures one or more paper physical properties of a recording medium, includes an acquisitor that acquires, from the first media sensor, first detection data constituted by a measurement result of one or more paper physical properties obtained by measuring a recording medium; a converter that converts the acquired first detection data into conversion data being information on a basis of a measurement result of the second media sensor, and an output unit that outputs conversion data converted by the converter.

In order to realize the above-described object, a computer-readable recording medium, which reflects one aspect of the present invention, stores a control program to control a converting device for use in a media detecting system that include a first media sensor that includes one or more internal sensors and measures one or more paper physical properties of a recording medium and a second media sensor that includes one or more internal sensors and measures one or more paper physical properties of a recording medium, the control program adapted to make a computer to execute processing, the processing including: (a) acquiring, from the first media sensor, first detection data constituted by a measurement result of one or mom paper physical properties obtained by measuring a recording medium; (b) converting the first detection data acquired in (a) into conversion data being information on a basis of a measurement result of the second media sensor; and (c) outputs conversion data converted in (b).

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1A is a drawing showing a schematic configuration of a media detecting system according to the present embodiment.

FIG. 1B is a drawing showing a schematic configuration of a media detecting system according to a first modified example.

FIG. 1C is a drawing showing a schematic configuration of a media detecting system according to a second modified example.

FIG. 2 is a configuration table showing a type and performance of an internal sensor mounted on a media sensor 80 of each generation.

FIG. 3 is a graph showing a performance difference between an improved type and an old type in an internal sensor 1 (specular reflection sensor).

FIG. 4 is a graph showing a performance difference between an improved type and an old type in an internal sensor 2 (sensor for detecting transmitted-light (basic weight sensor)).

FIG. 5 is a graph in which accuracy information of each sensor is added to the graph in FIG. 3.

FIG. 6 is a drawing showing other examples of the media detecting system.

FIG. 7 is a block diagram showing a configuration of a converting device.

FIG. 8 is a block diagram showing a data flow in the converting device.

FIG. 9 is a schematic diagram showing a control parameter deciding method I of an image forming apparatus.

FIG. 10 is a drawing showing the control parameter deciding method I.

FIG. 11A is a schematic diagram showing a control parameter deciding method II of the image forming apparatus.

FIG. 11B is a schematic diagram in which an output destination of the first to third conversion data generated by the converting apparatus is added to the schematic diagram in FIG. 11A.

FIG. 12 is a table in which the first, second, and third conversion data and the processing content of the converting device are summarized.

FIG. 13 is a drawing showing deciding processing coping with a Type1 media sensor in a control parameter deciding method II.

FIG. 14 is a drawing showing deciding processing coping with a Type3 media sensor in the control parameter deciding method II.

FIG. 15 is a schematic diagram showing a control parameter deciding method III.

FIG. 16 is a drawing showing deciding processing coping with a Type3 media sensor in the control parameter deciding method III.

FIG. 17 is a drawing showing converting processing information (conversion table) in a combination of each Type of a conversion source apparatus and a use destination apparatus.

FIG. 18 is a block diagram showing a configuration of a memory device.

FIG. 19 is a flowchart showing reading-out processing of a data converting method.

FIG. 20 is a subroutine flowchart showing processing-content deciding processing in Step S12 in FIG. 19.

FIG. 21 is a subroutine flowchart showing converting-processing-information updating processing in Step S116 in FIG. 20.

FIG. 22 is a flowchart showing conversion setting processing at the time of creating conversion data from detection data.

FIG. 23 is a drawing showing an example of a setting screen indicated on a display of a control device of the image forming apparatus and so on.

FIG. 24A is a flowchart showing detail setting processing of conversion setting.

FIG. 24B is a subroutine flowchart showing candidate list automatically-selecting processing in Step S45 in FIG. 24A.

FIG. 25A is a drawing showing an example of a detail setting screen indicated on the display of the control device of the image forming apparatus and so on.

FIG. 25B is a drawing showing an example of a detail setting screen indicated on the display of the control device of the image forming apparatus and so on.

FIG. 26 is a drawing showing a priority ranking to be used in selection in automatic setting.

FIG. 27 is a drawing for describing an example to convert into any one of the second and third media sensor in other example.

FIG. 28 is a flowchart showing printing processing.

FIG. 29 is a subroutine flowchart showing actual printing preparing processing in Step S05 in FIG. 28.

FIG. 30 is a subroutine flowchart showing control parameter deciding processing 1 in Step S52 in FIG. 29.

FIG. 31A is a subroutine flowchart showing data converting processing in Step S503 (and S603).

FIG. 31B is a subroutine flowchart showing processing subsequent to the processing in FIG. 31A.

FIG. 32 is a subroutine flowchart showing actual printing processing in Step S06 in FIG. 28.

FIG. 33 is a subroutine flowchart showing control parameter deciding processing 2 in Step S62 in FIG. 32 and control parameter deciding processing 3 in Step S69.

FIG. 34 is a drawing showing a schematic configuration of an image forming apparatus equipped with a built-in media sensor.

FIG. 35 is a side view of a periphery of a built-in media sensor.

FIG. 36A is a drawing showing a schematic configuration of a paper conveying device equipped with a built-in media sensor.

FIG. 36B is a drawing showing a schematic configuration of a post processing device equipped with a built-in media sensor.

FIG. 37 is a drawing showing a schematic configuration of a media detecting system including an image forming system equipped with an image forming apparatus and a paper conveying device.

FIG. 38A is a perspective view, FIG. 38B is a side view, and each of FIG. 38A and FIG. 38B shows an appearance of the external media sensor.

FIG. 39A is a side view of an external media sensor, and FIG. 39B is a schematic top view showing a detection region and so on in a lower housing.

### DETAILED DESCRIPTION OF EMBODIMENTS

Hereinafter, with reference to attached drawings, embodiments of the present invention will be described. However, the scope of the invention is not limited to the disclosed embodiments. In this connection, in the description for the drawings, the same constitutional element is provided with the same reference symbol, and the overlapping description is omitted. Moreover, dimensional ratios in the drawings are exaggerated on account of description and may be different from the actual ratios. In the present embodiment, in a recording medium, a print paper (hereinafter, merely referred to as a paper) and various films are included. In particular, as a paper, those produced by using plant-derived mechanical pulp and/or chemical pulp are included. Moreover, as a type of recording medium, a gross paper, mat paper, regular paper, high gloss paper, etc. are included.

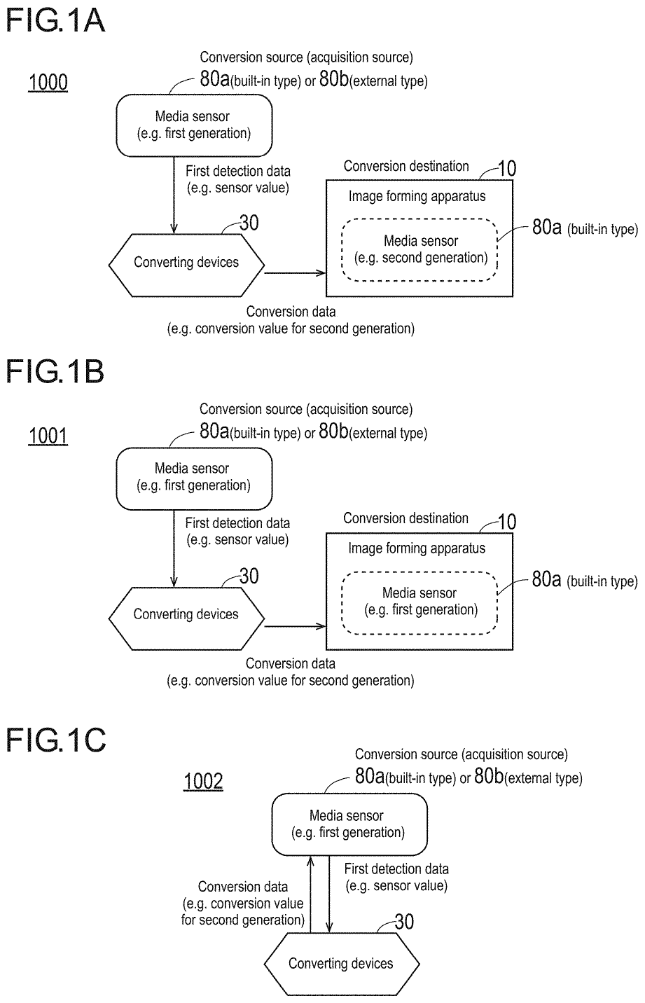

FIG. 1A is a drawing showing a schematic configuration of a media detecting system 1000 according to the present embodiment. The media detecting system 1000 includes a first media sensor 80a or 80b, a second media sensor 80a, and a converting device 30. Media sensors includes a built-in (also referred to as “in-line”) media sensor 80a that is built in other apparatus such as an image forming apparatus 10 and an external (also referred to as “off-line”) media sensor 80b that is independent of the other apparatus (hereinafter 80a and 80b are also collectively referred to as a media sensor 80). Each media sensor 80 includes one or more internal sensors and measures one or more paper physical properties by measuring a recording medium. For example, the media sensor 80 includes a plurality of internal sensors and measures paper physical properties, such as a paper thickness, a basic weight, a surface nature, an electric resistance, an electrostatic property, a bending strength, and so on by the respective internal sensors.

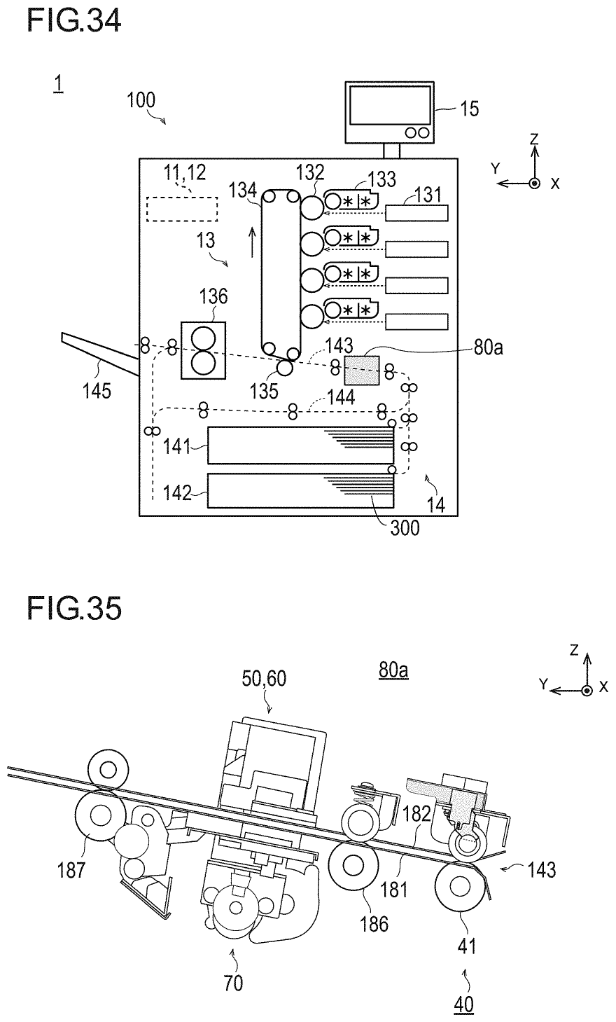

The first media sensor 80 is a media sensor of an acquisition source (conversion source) and outputs first detection data constituted by a plurality of measured paper physical properties. The second media sensor 80 is a sensor unit that operates in an interlocking manner with an image forming apparatus 10 (or a below-mentioned paper conveying device 20 or a post processing device 25) that is an output apparatus at the last stage. The image forming apparatus 10 sets up control parameters with regard to image formation and paper conveyance on the basis of detection data (also referred to as second detection data) from the second media sensor. A data conversion is performed, when a function differs from the engine performance between the first and second media sensor so that it may mention later. As mentioned later, in a case where performance and function differs between the first and second media sensors, data conversion is performed. For example, in the case where the first media sensor is an old type and the second media sensor is a new type, the converting device 30 performs data conversion of up-convening so that the image forming apparatus 10 can use the first detection data of the first media sensor. Moreover, on the contrary, in the case where the first media sensor is a new type and the second media sensor is an old type, the converting device 30 performs data conversion of down-converting so that the image forming apparatus 10 can use the first detection data of the first media sensor. An example of a machine configuration of the media sensors 80a and 80b and the image forming apparatus 10 will be mentioned later (below-mentioned FIG. 34 to FIG. 39B).

Besides the mode shown in FIG. 1A, a configuration may be made as shown in FIG. 1B and FIG. 1C. In the first modified example shown in FIG. 1B, the detection data (the first detection data (f the first generation) of the first media sensor of an acquisition source is converted into the detection data (the second detection data of the second generation) of the second media sensor by the converting device 30 and is sent to the image forming apparatus 10. In the second modified example shown in FIG. 1C, the detection data (the first detection data of the first generation) of the first media sensor of an acquisition source is converted into the detection data (the second detection data of the second generation) of the second media sensor by the converting device 30 and is returned to the media sensor 80a. These converted data is used by another image forming apparatus equipped with the media sensor 80 of the second generation, thereby deciding control parameters.

(Difference in Performance and Function Between Generations (Between Types) in Media Sensor 80)

Each media sensor 80 has a plurality of generations or types (also referred to as a “version number”) (hereinafter, these are also referred to as “Type”) different in market launching timing, and for each generation, there is a difference in type (number) or sensor characteristic of an internal sensor. Moreover, there is a difference in type and/or performance of measurable paper physical properties. Generally, the newer, generation is, the more, the types of measurable paper physical properties become. Moreover, the newer, the generation is, the more, the performance (sensitivity, measuring range) and accuracy of the sensor can be improved, and the wider the detection range becomes.

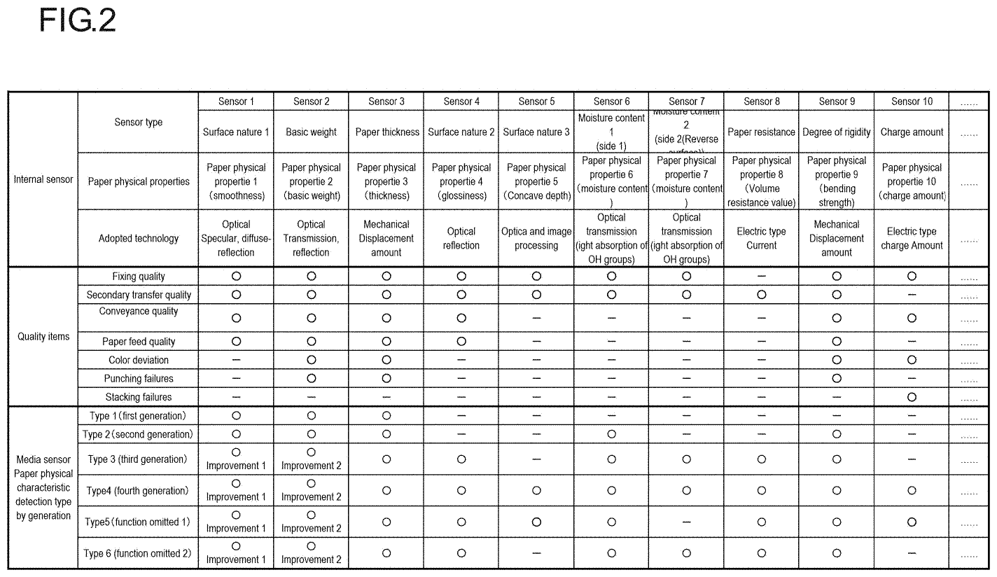

FIG. 2 is a configuration table showing the type and performance of an internal sensor mounted on the media sensor 80 of each generation. The above drawing (FIG. 2) shows that, as an example, ten internal sensors capable of measuring respective ten types of paper physical properties are mounted on which generation. The circle mark indicates application or mounting. In this connection, the above drawing shows merely an example, and the number of types of paper physical properties and the number of internal sensors are not limited to the above example and may be applied with an arbitrary number. Moreover, on the apparatus side, identification of respective types and a configuration of an internal sensor to be mounted can be identified on the basis of identification information (product type information). Moreover, in the image forming apparatus 10, the configuration information (refer to later-mentioned FIG. 27) with regard to the existence or nonexistence of a double-sided printing function, the existence or nonexistence of an electric charge eliminating function, the existence or nonexistence of correspondence to an embossed paper, etc. can be determined on the basis of identification information. The electric charge eliminating function eliminates charges on a paper, thereby preventing the paper from attaching to other papers or other members (members on a conveyance passage) due to static electricity. The correspondence to an embossed paper is a configuration that corresponds to unevenness on the surface of an embossed paper and increases transferability. For example, by using a transfer roller whose material is made correspondent to embossment or by changing a transfer pressure to a high pressure, the surface of the transfer roller is made to follow unevenness easily. Alternatively, by making a transfer current large, the transferability in a concave portion is made to increase.

In a “surface nature 1”, a state of a surface nature is detected as a physical property corresponding to a smoothness of a surface nature of a paper by an internal sensor 1. This surface nature 1 is detected by a later-mentioned surface nature detector (surface nature detector 60 in FIG. 35), for example, light is irradiated at an incident angle of 75 degrees on a surface of a paper, and then specularly-reflected light and diffusely-reflected light from the surface of the paper are detected optically by two sensors.

In a “basic weight”, a physical property corresponding to a basic weight of a paper is detected by an internal sensor 2. This basic weight is detected by a later-mentioned basic weight detector (basic weight detector 50 in FIG. 35), and an amount of attenuation (transmissivity) of light that penetrates a paper, is measured by optical sensors of a transmission type and a reflection type.

In a “paper thickness”, a physical property corresponding to a thickness of a paper is detected by an internal sensor 3. In this paper thickness, by a later-mentioned paper thickness detector (paper thickness detector 40 in FIG. 35), paper is sandwiched between two members, and then a thickness of a paper is mechanically measured by a distance between the two members.

In a “surface nature 2”, a physical property corresponding to a glossiness of a surface nature of a paper is detected by an internal sensor 4. In this surface nature 2, light is irradiated at a predetermined incident angle on a surface of a paper, and then specularly-reflected light from the surface of the paper are detected optically.

In a “surface nature 3”, a degree of concavo-convex of a surface nature of a paper is detected by an internal sensor 5. For example, light is irradiated to a surface of a paper at a large incident angle (80 degrees or more and less than 90 degrees), and then the surface of the paper in this state is photographed and the obtained image data is subjected to image processing, whereby an index with regard to an amount of depth corresponding to a concavo-convex state of the surface is output as a measurement result.

In a “moisture content 1”, a physical property corresponding to a moisture content of a paper is detected by an internal sensor 6. This moisture content on be measured, for example, by a moisture content sensor of a near-infrared system that detects optically an amount of light absorption of OH groups from light transmitted a paper. Moreover, as another example, a change amount of a light amount of a reflected component in an inside of a paper may be measured by using reflected light separated by a polarizing filer.

A “moisture content 2” is measured by a same type sensor as the internal sensor 6 of the moisture content 1 by an internal sensor 7. However, an arrangement position is different from that of the internal sensor 6. Although an internal sensor for the moisture content 1 may be mounted on the media sensor 80 of a built-in type or an external type, an internal sensor of the moisture content 2 is mounted only on the media sensor 80 built in the image forming apparatus 10 (or paper conveying device 20). In concrete terms, the moisture content 1 is obtained by measuring a paper before passing the fixing device (device to perform heating and pressing processing for a paper) of the image forming apparatus 10, and the moisture content 2 is obtained by measuring a paper after having passed the fixing device.

In a “paper resistance”, a physical property corresponding to an electric resistance of an inside or on a surface of a paper is detected by an internal sensor 8. For example, a high voltage is applied to a paper and the paper resistance is measured electrically from a voltage and a flowing current at that time.

In a “degree of rigidity”, a physical property corresponding to a rigidity of a paper is detected by an internal sensor 9. For example, when a paper is conveyed on a curved conveyance path, a force with which a paper pushes an outside guide plate that is one of guide plates constituting a conveyance passage on a curved conveyance passage, or an amount of displacement is measured mechanically.

In a “charge amount”, a physical property corresponding to a charging characteristic of a surface of a paper is detected by an internal sensor 10. For example, the internal sensor 10 is a non-contact electric-potential sensor.

The paper physical properties 1 to 10 obtained by the respective internal sensors 1 to 10 influence respective quality items, such as fixing quality, a secondary transfer quality, a conveyance quality of a paper, a paper feed quality of a paper from a paper feed tray, a color deviation, punching failures, and stacking failures. Among these, the color deviation is color deviation (position deviation between colors in multiple colors) due to vibration and shock when a paper rushes into a transfer nip. As post processing performed for a printed paper by a below-mentioned post processing device 25, there are punching processing, stacking processing, stapling processing, cutting processing, folding processing, perforating processing, and bookbinding processing. In the punching processing, holes are pierced in a paper. In the stacking processing, when performing each post processing, plural sheets of papers are stacked. In the stapling processing, plural sheets of papers are bound with a staple. In the cutting processing, a paper is cut out by a cutter. In the folding processing, processing to fold a paper in multiple stages, such as folding in two stages, folding in three stages (folding in z stages), is included. In the perforating processing, perforations for cutting are provided on a paper. In the bookbinding processing, an end (back) portion of a bundle of a plurality of papers is coated with a paste, and the bundle is covered with a cover sheet. Poor cutting, poor folding, poor perforating, and poor past coating are quality items with regard to these post processing.

Moreover, as shown in the table in FIG. 2, the type and performance of an internal sensor to be mounted are different depending on each generation (Type1 to Type6). For example, in the media sensor 80 of Type1 (the first generation), only the internal sensors 1 to 3 are mounted, and in the media sensor 80 of Type4 (the fourth generation), all the internal sensors 1 to 10 are mounted. In this connection, each of “improvement 1” of the internal sensor 1 and “improvement 2” of the internal sensor 2 represents an improved type in which performance has been improved.

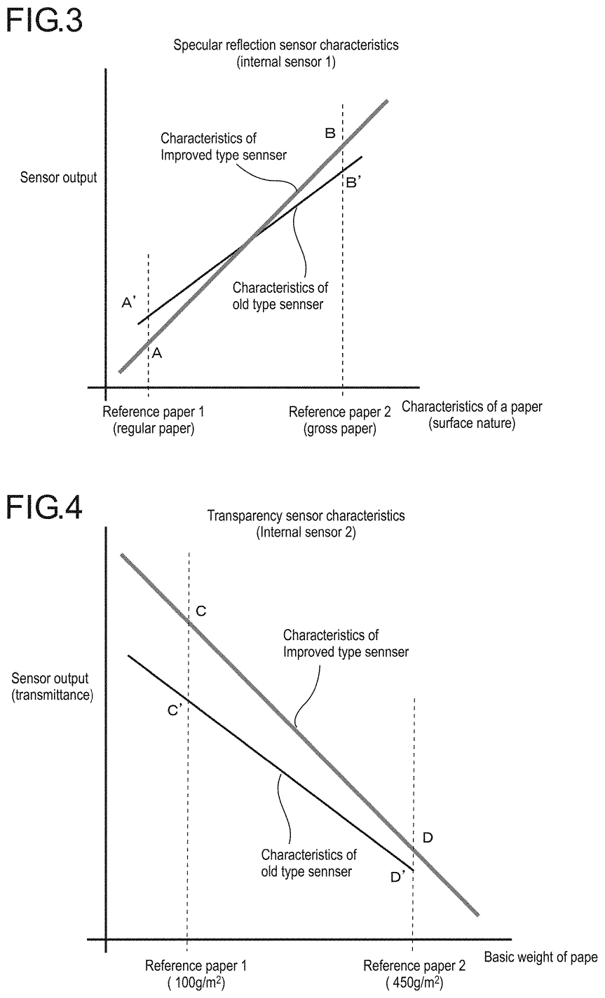

FIG. 3 is a graph showing a difference in performance between an improved type and an old type in the internal sensor 1 (specular reflection sensor). As mentioned in the above, in the sensor of the internal sensor 1 to detect specularly-reflected light, as compared with the old type of the sensor, in the improved type, the sensitivity is higher and the sensing range is wider. Accordingly, the performance has been improved.

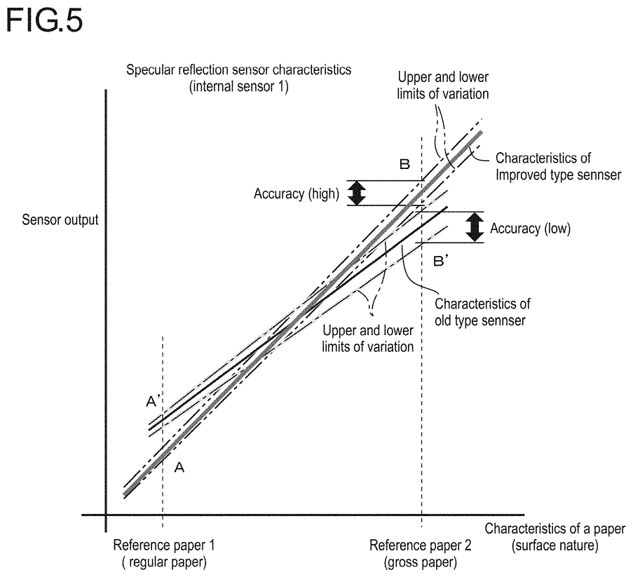

FIG. 4 is a graph showing a difference in performance between an old type and an improved type in a sensor (basic weight sensor) of the internal sensor 2 for detecting transmitted light. Similar to FIG. 3, in the sensor of the internal sensor 2, as compared with the old type, in the improved type, the sensitivity is higher and the sensing range is wider. Accordingly, the performance has been improved.

Moreover, as a difference in the performance of a sensor, there is an accuracy other than the sensitivity and the sensing range. FIG. 5 is a graph in which accuracy information (variation) of each sensor is added to the graph in FIG. 3. As compared with an old type, in an improved type, a range of the upper and lower limits of variation compensated by a sensor is narrower, and accuracy is higher.

(Various Types of Cooperation Modes of Media Sensor 80)

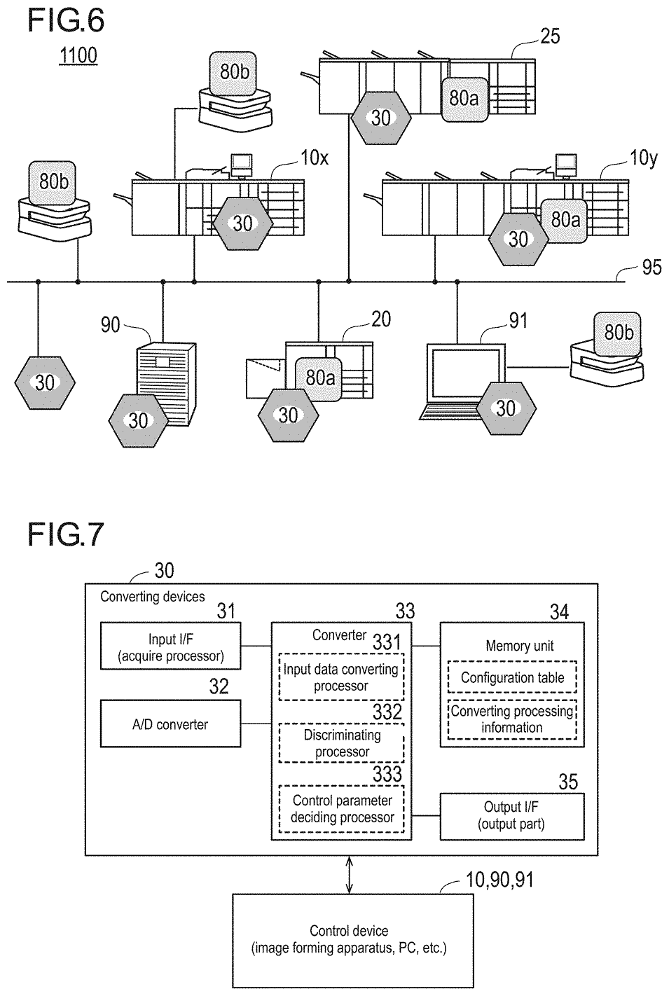

FIG. 6 is a drawing showing other examples or a media detecting system 1100. In an example shown in FIG. 6, the media detecting system 1100 includes a plurality of image forming apparatuses 10x and 10y, a paper conveying device 20, a post processing device 25, a server 90, an information processing device 91, a plurality of media sensors 80a and 80b, and a plurality of convening devices 30. These apparatuses are mutually connected through a network 95 so as to communicate with each other. The generation of each of the media sensors 80a and 80b is any one of the above-mentioned Type1 to Type6. As shown in the above drawing (FIG. 6), the converting device 30 may be arranged alone on the network, may connected locally to the server 90, the information processing device 91, or the like, or may be built in (so as to operate in a processor). Alternatively, the converting device 30 may be built (so as to operate in a processor) in the image forming apparatuses 10x and 10y and the media sensor 80b.

The image forming apparatus 10x is connected to the media sensor 80b of an external type or incorporates the converting device 30 therein. The connection between the image forming apparatus 10x and this media sensor 80b is made with a wired-connection by a cable, such as USB. Moreover, this connection may be made with a wireless connection by short-distance wireless communication such as Bluetooth (registered trademark). The image forming apparatus 10y incorporates the media sensor 80a and the converting device 30 therein. The paper conveying device 20 sets various fixed standard size papers such as a A3 size paper or a long paper with a length of 1300 mm, feed a paper automatically, and measures the physical properties of a paper by a built-in media sensor 80a. This paper conveying device 20 may be connected to the image forming apparatus 10 or may function alone as a collator. The post processing device 25 applies various types of post processing to printed papers having been processed in the image forming apparatus 10 and so on. This post processing device 25 may be used by being combined with the image forming apparatus 10 or the paper conveying device 20, or may be used alone. In the post processing device 25, post processing control parameters are decided on the basis of the measurement result of the media sensor 80a, and the post processing is controlled with the parameters.

The server 90 incorporates the converting device 30 therein. In this connection, the server 90 may be a cloud server virtually constituted by a plurality of servers disposed on a networks, such as the internet. In this case, the converting device 30 functions on the cloud server. Moreover, without utilizing the network 95, the image forming apparatus 10x connected to each of the media sensor 80 and the converting device 30 with a cable and the image forming apparatus 10y may be wirelessly connected directly to each other in a mode of P2P. The information processing device 91 is a PC (personal computer). The information processing device 91 is wired or wirelessly connected to the media sensor 80b of an external type. Moreover, the information processing device 91 may incorporate the converting device 30 therein.

In this way, the measurement result (the first detection data) of the paper physical properties obtained by measuring a paper by the first media sensor 80 is converted into conversion data being the information on the basis of the measurement result of the second media sensor 80 by the converting device 30 through which the first detection data is received. Successively, the conversion data is sent to the image forming apparatus 10, the paper conveying device 20, or the post processing device 25 (hereinafter, these are also referred to as an apparatus of a conversion destination, an output destination, or a use destination) that are supposed to use this conversion data eventually, and the conversion data is used for setting control parameters in paper conveyance or image formation. As another example, the measurement result (the first detection data) of the paper physical properties obtained by measuring a paper by the first media sensor 80 is converted into conversion data in a format corresponding to a constitution of an apparatus that is supposed to use this conversion data eventually, by the converting device 30 through which the measurement result is sent. Successively, the conversion data is temporarily saved in other apparatus (a server 90 or an information processing device 91), thereafter, is sent to the image forming apparatus 10 and so on, and is used for setting control parameters in paper conveyance and image formation.

As a concrete example of an acquisition source front which the converting device 30 acquires the first detection data, there are (a1) direct acquisition from the first media sensor 80, (a2) the image forming apparatus 10 that cooperates with the first media sensor 80, (a3) the information processing device 91 that cooperates with the first media sensor 80, and (a4) the paper conveying device 20 or the post processing device 25 that cooperates with the first media sensor 80.

Moreover, as an output destination (use destination) of the conversion data that has been converted by the converting device 30 and is the information on the basis of the measurement result of the second media sensor 80, there are (b1) the first media sensor 80 connected to the network, (b2) the image forming apparatus 10 connected to the network, (b3) the information processing device 91 connected to the network, and (b4) a portable type memory device, such as a USB memory and so on that are connected to the converting device 30 with a cable. In a mode of this (b1), an acquisition source and an output destination are the same media sensor 80 (the second modified example in FIG. 1C). Moreover, in the image forming apparatus of this (b2),(b21) the image forming apparatus 10 (namely, (a1)) that cooperates with the first media sensor 80 and (b22) the image forming apparatus 10 that cooperates with the second media sensor 80, are further included. Moreover, the converting device 30 may be mounted on the image forming apparatuses 10x and 10y of these (b21) and (b22). In the second modified example in FIG. 1C, the paper physical property data that has used the sensor of the old generation is converted (for a purpose to increase accuracy) into data that matches the physical property output of the sensor (version-upgraded sensor) of the present generation, and then, the values of the data are returned to an image forming apparatus that is connected to the sensor of the old generation. With this, it is possible to decide control parameters in which accuracy has been increased.

In the format of the conversion data that is the information on the basis of the measurement result of the second media sensor 80, the first conversion data to the third conversion data are included. (1) The first conversion data is a conversion value (the second detection data) to the sensor output of the internal sensor of the second media sensor. (2) The second conversion data is data that has been calculated on the basis of this conversion value and is used for setting control parameters of an image forming apparatus. (3) The third conversion data is these control parameters. The format of these the first to third conversion data will be mentioned later.

(Configuration of Converting Device 30)

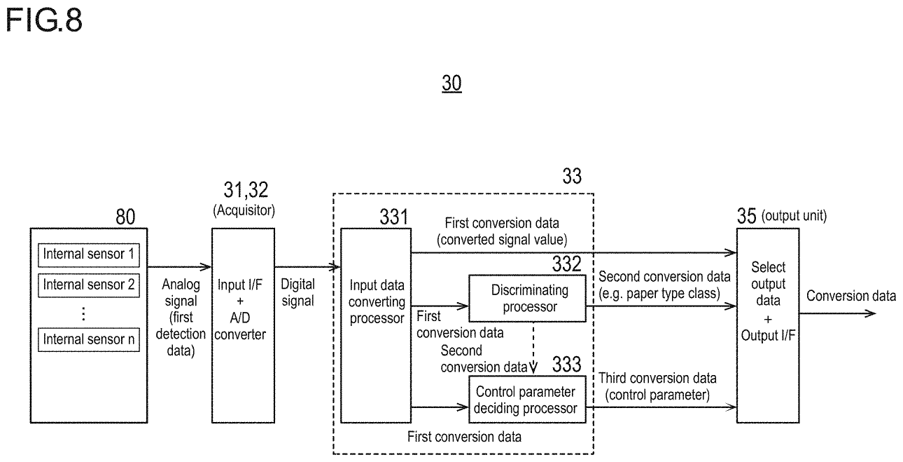

FIG. 7 is a block diagram showing the configuration of the converting device 30. FIG. 8 is a block diagram showing a data flow in the converting device 30. As shown in FIG. 7 and FIG. 8, the converting device 30 includes an input I/F (interface) 31, an A/D converter 32, a converter 33, a memory unit 34, and an output I/F 35.

(Input I/F 31 and A/D Converter 32)

The input I/F 31 is an electric connector or a network I/F conforming to an Ethernet standard etc., acquires the first detection data digitally converted from the media sensor 80, and, as shown in FIG. 8, acquires directly analog electrical signals from an internal sensor of the media sensor 80. The A/D converter 32 converts analog signals into digital signals. The input I/F 31 functions as an acquisitor by operating solely or cooperating with A/D converter 32.

(Converter 33)

The converter 33 includes a CPU, a ROM, a RAM, etc., executes various types of processing by executing programs stored in the ROM and a memory unit 34, and performs control for each unit of an apparatus and various types of arithmetic processing in accordance with a program. The converter 33 converts the first detection data of the first media sensor into conversion data being information based on the measurement result of the second media sensor interlocking with an output apparatus of an output destination, that is, into any one of the first to third conversion data described below. The converter 33 functions as an input data converting processor 331, a discriminating processor 332, and a control parameter deciding processor 333.

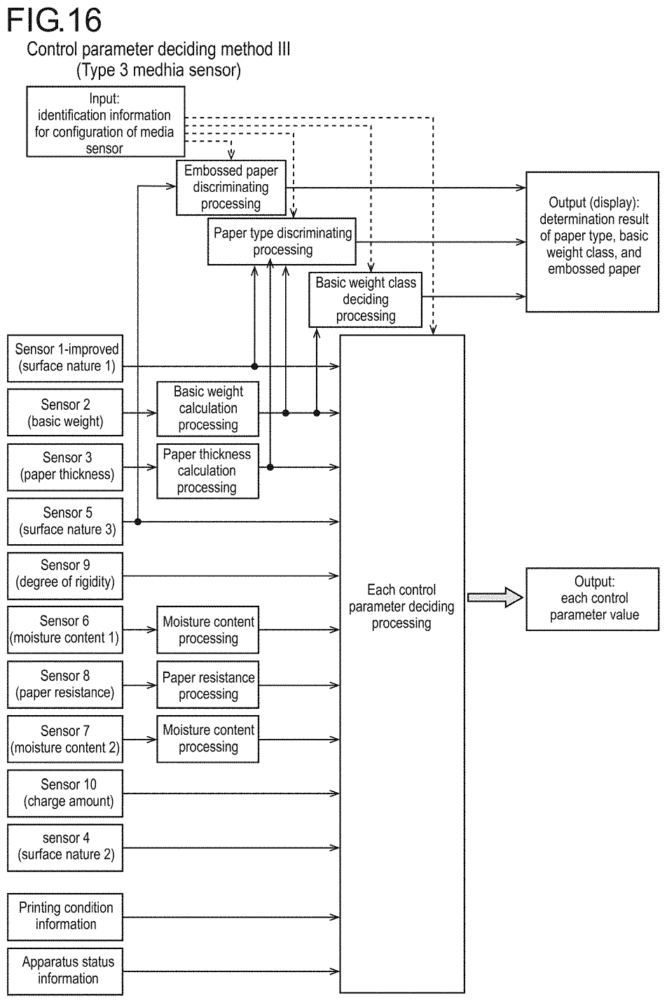

As shown in FIG. 8, the input data converting processor 331 creates “the first conversion data” mentioned later. On the Basis of the first conversion data sent from the input data converting processor 331, the discriminating processor 332 performs discriminating processing and creates classified “the second conversion data”. The second conversion data is the classification of each of a paper type and a basic weight, as described below. As the classification of the paper type, for example, there are a gross paper, a mat paper, a regular paper, and a high gloss paper, and as the classification of a basic weight, for example, there are 11 divisions divided at an arbitrary interval in a range of from 62 g/m² up to 350 g/m². The control parameter deciding processor 333 creates the third conversion data on the basis of the first conversion data sent from the input data converting processor 331. The third conversion data is control parameters used in the image forming apparatus 10, the paper conveying device 20, or the post processing device 25. This conversion from the first conversion data to the third conversion data can be performed by the processing similar to a later-mentioned control parameter deciding method III (refer to HG. IS and FIG. 16). In this connection, the control parameter deciding processor 333 receives the second conversion data (classified data) from the discriminating processor 332, and then may create the third conversion data from this second conversion data (shown with a broken-line arrow mark in FIG. 8). This conversion from the second conversion data to the third conversion data can be performed by the processing similar to a later-mentioned control parameter deciding method II.

(Memory Unit 34)

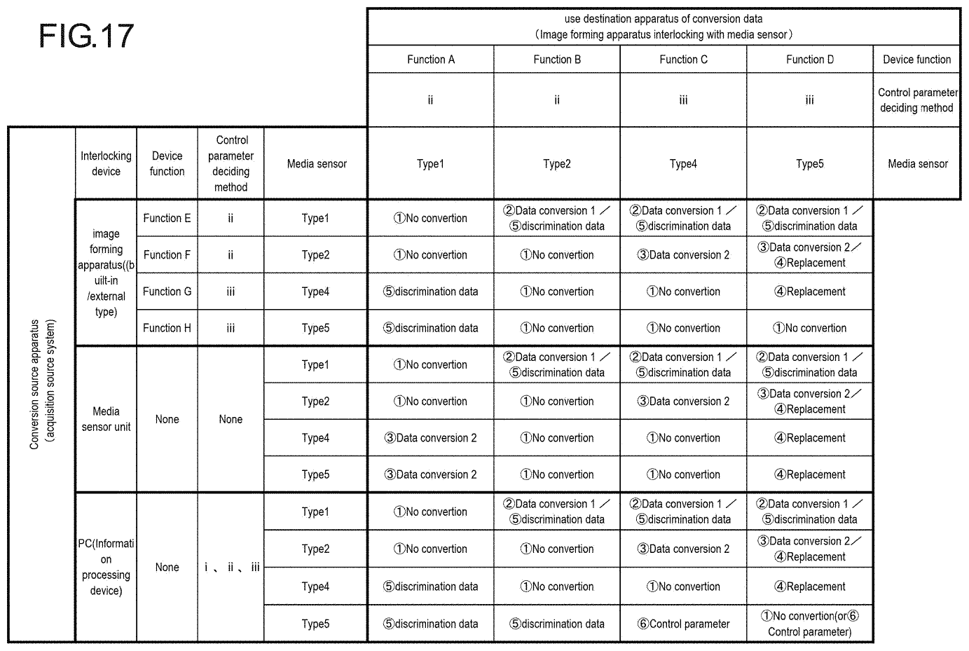

The memory unit 34 acquires the identification information for identifying the type of each of the media sensor 80 of an acquisition source and the image forming apparatus 10 and memorizes this. Moreover, the memory unit 34 acquires the identification information for identifying the type of each of the media sensor 80 of a conversion destination or a use destination, the image forming apparatus 10, the paper conveying device 20, and the post processing device 25 and memorizes them. These pieces of acquired identification information are memorized in respective apparatuses. Moreover, a configuration table that describes a constitution of sensors in each piece of identification information is memorized (refer to FIG. 2). Furthermore, the memory unit 34 memorizes the converting processing information (refer to below-mentioned FIG. 17) for performing converting processing in a combination of these pieces of identification information.

(Output I/F 35)

The output I/F 35 is an electric connector or a network I/F conforming to an Ethernet standard etc., selects the created first to third conversion data, and outputs them to an apparatus such as the image forming apparatus 10 and server 90. The output I/F 35 functions as an output unit.

Moreover, the converting device 30 is controlled by a control device prepared separately. The control device includes a CPU, a RAM, a ROM, etc. and controls an operation of the converting device 30. This control device may be a controller that controls the image forming apparatus 10, the paper conveying device 20, or the post processing device 25, may be a processor disposed in the inside of the media sensor 80, and may be the information processing device 91 (PC).

(Control Parameter Deciding Method and First to Third Conversion Data)

(Control Parameter Deciding Method I)

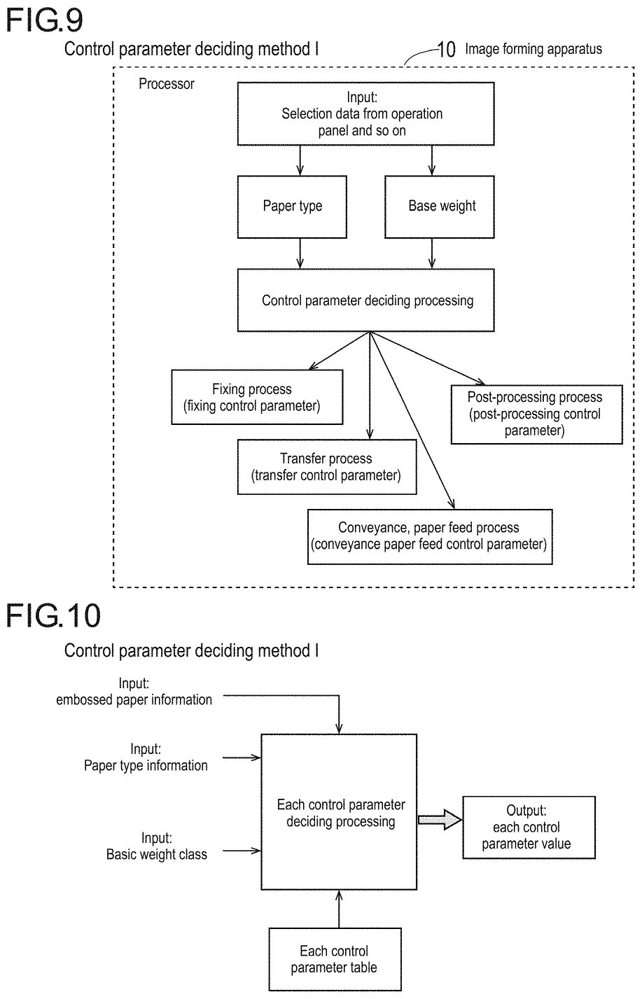

FIG. 9 is a schematic diagram showing a control parameter deciding method I of the image forming apparatus 10, and FIG. 10 is a drawing showing deciding processing in the deciding method I. This control parameter deciding method I is a method having been used widely conventionally, and although the control parameter deciding method I is not directly related to the present embodiment, it is indicated as reference. In this deciding method I, a user inputs the paper type of a paper to be used and a basic weight (weight) from an operation panel etc. of the image forming apparatus 10. The processor of the image forming apparatus 10 refers to respective control parameter tables memorized beforehand in a memory in accordance with respective combinations of the paper type of a paper and a basic weight. Successively, the processor decides control parameters for a fixing process, a transferring process, a conveying and paper feeding process, and a postprocessing process. Here, the control parameter in the conveying and paper feeding process is a conveying timing of a paper from a paper feed tray, a rotation speed of a roller at the time of conveyance, or a re-operation timing of a registration roller disposed just before a transfer position, which is decided according to the paper type/basic weight of a paper. The control parameters in the transferring process are an output of each of a voltage and current at the time of transferring a toner image on a secondary-transfer belt onto a paper in an electro-photographing method. The control parameter in the fixing process is a setting value of a control temperature and pressure of a fixing member or a conveyance speed of a paper at the time of fixing a toner image onto a paper with heating and pressing by a fixing device. The control parameter in the post-processing process is a setting value of an amount of a punching depressing force in a punching process, an amount of a depressing force and an amount of movement of a stacking alignment plate in a stacking process, an amount of a depressing force of a creaser in a folding process and a perforating process, an amount of a depressing force of a cutter in a cutting process, or an amount of coated glue in case binding in a book-binding process.

In an example in FIG. 10, unlike FIG. 9, embossed paper information is input separately from a paper type. The processor of the image forming apparatus 10 decides control parameter values on the basis of the embossed paper information, the paper type information, and the basic-weight information that have been input by a user and, on the basis of the decided control parameter values, controls functional members in the image forming apparatus 10, i.e., a fixing device, a transferring unit, and a paper feed conveyor.

(Control Parameter Deciding Method II)

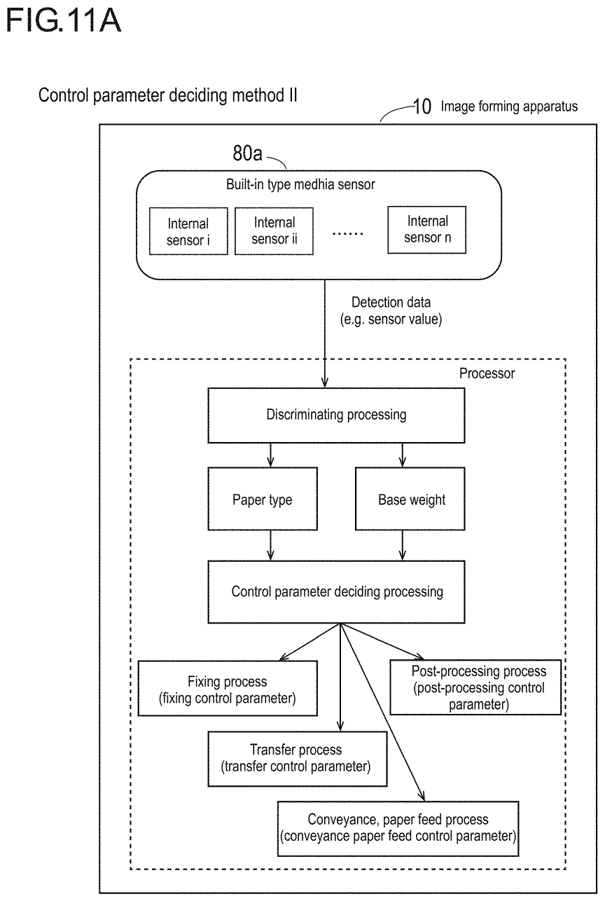

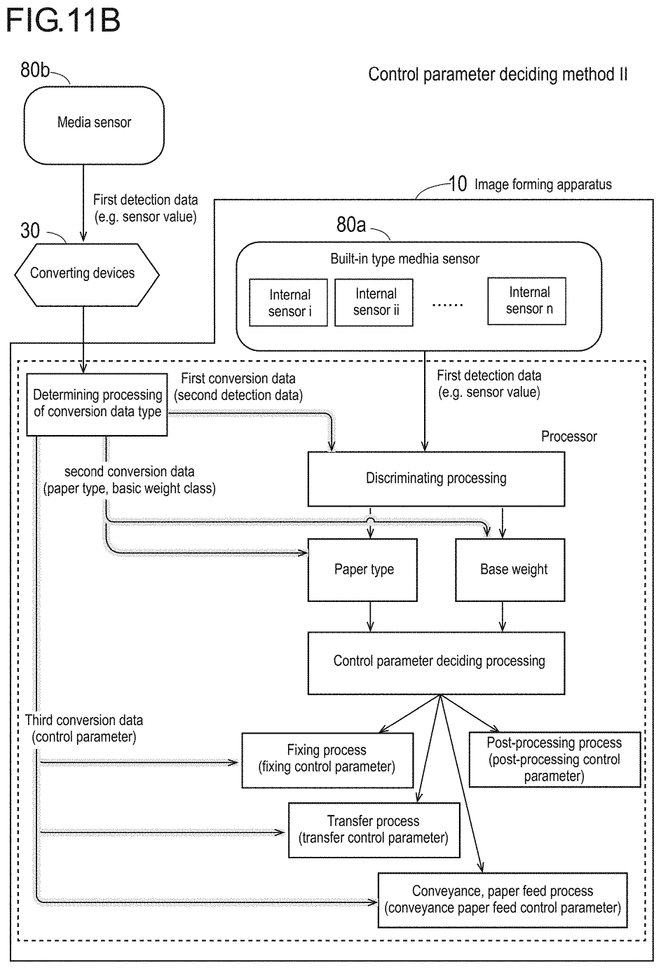

FIG. 11A is a schematic diagram showing the control parameter deciding method II of the image forming apparatus 10. FIG. 11B is a schematic diagram in which the output destination of each of the first to third conversion data is added to FIG. 11A. In this method II, on the basis of the detection data (the first detection data or the second detection data) obtained from each internal sensor of the media sensor 80a, the processor of the image forming apparatus 10 performs discriminating processing of a paper type and a basic weight. On the basis of the paper type and basic weight classified by the discriminating processing, the processor performs the control parameter deciding processing and decides each control parameter. The control parameter deciding processing is basically similar to the deciding method I, except that the number of divisions of each of the paper type and basic weight differs.

(First Conversion Data)

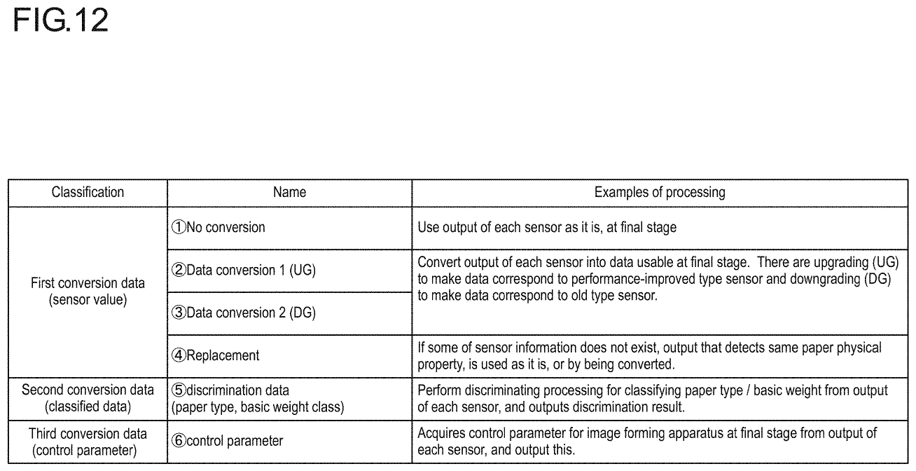

FIG. 12 is a table in which the first, second, and third conversion data described below and the processing content of the converter 33 are summarized. First, the first conversion data is described with reference to FIG. 8 and FIG. 11B.

At the time of converting into the first conversion data by the input data converting processor 331 of the converter 33, the converting device 30 grasps the Type (refers to above-mentioned FIG. 2) of the media sensor 80 interlocking with the image forming apparatus 10, for example, the built-in media sensor 80 on the basis of the identification information corresponding to the configuration of the media sensor 80. Successively, on the basis of a difference in the type and performance of the internal sensor of the media sensor 80, the converting device 30 performs the first converting processing of a measured value by a conversion formula or a conversion table and creates the first conversion data. The first conversion processing includes (1) no conversion, (2) data conversion 1, (3) data conversion 2, and (4) replacement, as shown in FIG. 12. Hereinafter, description will be given in the order.

(1) No Conversion as First Converting Processing

There is a case where the Type is the same between the first and second media sensors, or a case where the Type is different, but some internal sensors are common. For example, in FIG. 2, since the internal sensors 1 to 3 are common between Type1 and Type2, the input data converting processor 331 outputs the values of the detection data of these sensors with no conversion without converting, as they are. Moreover, between Type3 and Type1, the sensors 1, 2, and 4 have non-common performance with each other and are sensors to measure the respective same paper physical properties, and the sensors 3 are sensors having a common performance with each other. In this case, the input data converting processor 331 applies no conversion for the common sensors 3 and performs data conversion by the first converting processing (data conversion 1, data conversion 2, or replacement) described below for only the non-common sensors 1, 2, and 4.

(2) Data Conversion 1 as First Conversion Process

For example, in an example shown in FIG. 3, in the case of matching the output of an improved type sensor with the output of the old version sensor thereinafter, also referred to as downgrading (DG) or data conversion 2), the input data converting processer 331 of the converter 33 adds an offset component to the output value of A point so as to match with A′ point and multiplies the inclination of the characteristic by a correction factor so as to match the output value of B point with B′ point.

(3) Data Conversion 2 as First Conversion Process

Conversely, in the case of matching the output of an old type sensor with the output of an improved type sensor (hereinafter, also referred to as upgrading (UG) or data conversion 1), the input data converting processer 331 of the converter 33 reduces an offset value from the output value of A′ point so as to match with A point and multiplies the inclination of the characteristic by a correction factor so as to match the output value of B′ point with B point. Also, in the case of the sensor shown in FIG. 4, by performing the similar processing for the outputs at C, C′, D, and D′ points, processing of the data conversions 1 and 2 can be performed.

(4) Replacement as First Converting Processing

In the case where there does not exist a part of sensor information, as replacement, the input data converting processor 331 of the converter 33 uses an output which detects the same paper physical properties, as it is, or by converting it. For example, in FIG. 2, in Type4 and Type5, the internal sensor 7 does not exist on the media sensor side of Type5. Such a case where the first media sensor 80 of an acquisition source is Type5 and the second media sensor 80 cooperated by the image forming apparatus 10 of a use destination of the conversion data is Type4, is described as an example.

In this case, since the detection data of the paper physical property 7 (moisture content) of the internal sensor 7 does not exist originally, the detection data of the same paper physical property 6 (moisture content) before fixing is used as substitution. That is, the correction data obtained by converting the detection data of the internal sensor 6 by using a correction coefficient specified beforehand on the basis of the type of each image forming apparatus 10, a fixing setting temperature, a fixing speed, and a temperature inside the apparatus, is used by replacing as the detection data of the internal sensor 7. As another technique, without correcting, the detection data of the internal sensor 6 may be replaced as it is and may be used as a detection data of the internal sensor 7, or a fixed value may be replaced to it. However, in the case of using such an another technique, there is a concern that quality may deteriorate. However, in the case of giving priority to that printing becomes possible by deciding a final control parameter, it may be used as the next best disposal.

(Second Conversion Data)

The second conversion data is a discrimination result into which a paper type and a basic weight are classified. FIG. 8 and FIG. 11B are referred to again. The discriminating processor 332 creates data that is calculated on the basis of the first conversion data (conversion value) and used for setting a control parameter of an image forming apparatus, i.e., creates the second conversion data. In concrete terms, the discriminating processor 332 discriminates that a paper kind and basic weight are any one of a plurality of classified paper types and any one of a plurality of classified basic weights by the discriminating processing. For example, the second conversion data whose paper type class is a “regular paper” and whose basic weight class is “75 to 81 g/m”, is created.

(Third Conversion Data)

The third conversion data is a control parameter set in accordance with a paper used in the image forming apparatus 10 (or the paper conveying device 20 or the post processing device 25) of an output destination. As shown in FIG. 8 and FIG. 11B, the control parameter deciding processor 333 decides a control parameter directly from the first conversion data (detection data) by the processing similar to a control parameter deciding method III described below. Alternatively, the control parameter deciding processor 333 decides a control parameter by using data that has been converted once into the second conversion data (a paper type and a basic weight class) from the first conversion data by the processing similar to a control parameter deciding method II shown in FIG. 11A. The communication data of each of the first to third conversion data sent from the converting device 30 is provided with a type identification code (henceforth, merely referred to as an “identification code”; identification code: for example, 1, 2, and 3 of the identification number indicate the first to third conversion data, respectively). In the discriminating processing to discriminate the type of the conversion data in FIG. 11B, the sending destination of conversion data is decided on the basis of this identification code.

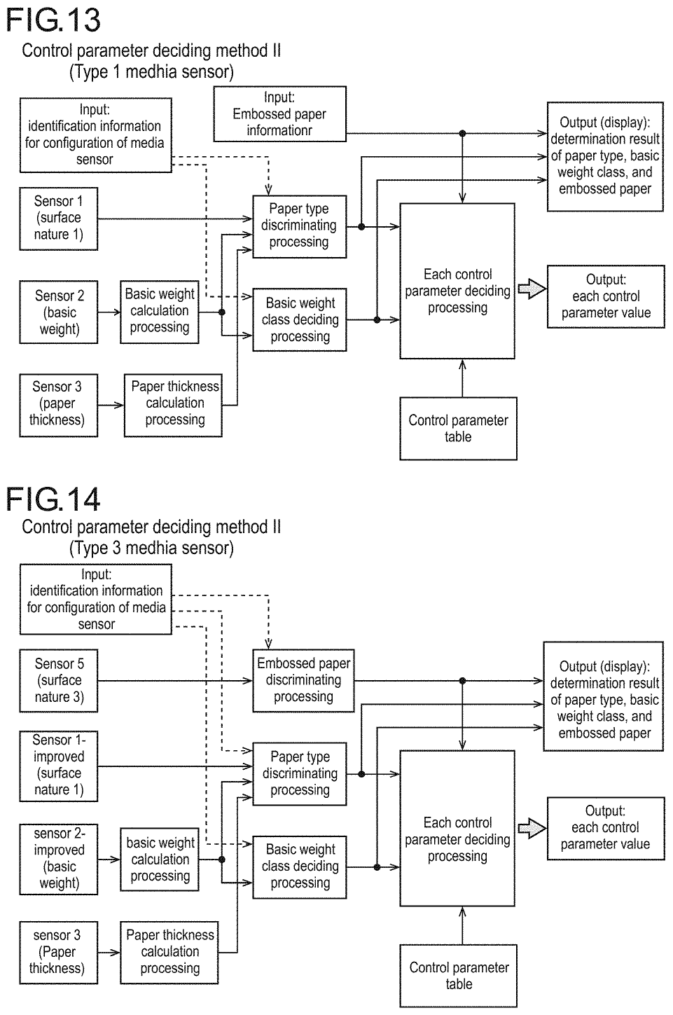

FIG. 13 is a diagram showing the deciding processing corresponding to the media sensor 80 of Type1 in the control parameter deciding method II. FIG. 14 is a diagram showing the deciding processing corresponding to the media sensor 80 of Type3 in the control parameter deciding method II. These processing modes are processing corresponding to the diagram in FIG. 11A, and in FIG. 13 and FIG. 14, whether the output of each internal sensor is used for which process in accordance with the type of the media sensor 80, is indicated in more details. For example, as shown in FIG. 14, the discriminating processing of an embossed paper is performed on the basis of the detection data of the sensor 5. Moreover, the paper type discriminating processing is performed on the basis of the detection data of sensor 1—improved, sensor 2—improved, and sensor 3, and the basic weight class deciding processing is performed on the basis of the detection data of sensor 2—improved.

In the processing as shown in FIG. 13 and FIG. 14, in the case where the converting device 30 performs (1) the paper type discriminating processing and the basic weight class deciding processing or (2) each control parameter deciding processing, the converting device 30 grasps, from the identification information, the Type of the media sensor 80 interlocking with an image forming apparatus that performs output eventually. Successively, by an algorithm according to a combination of corresponding Types, the converting device 30 performs the processing of any one of this (1) and (2). This discrimination of the processing of (1) and (2) is performed on the basis of the identification code provided to the conversion data sent from the converting device 30.

(Control Parameter Deciding Method III)

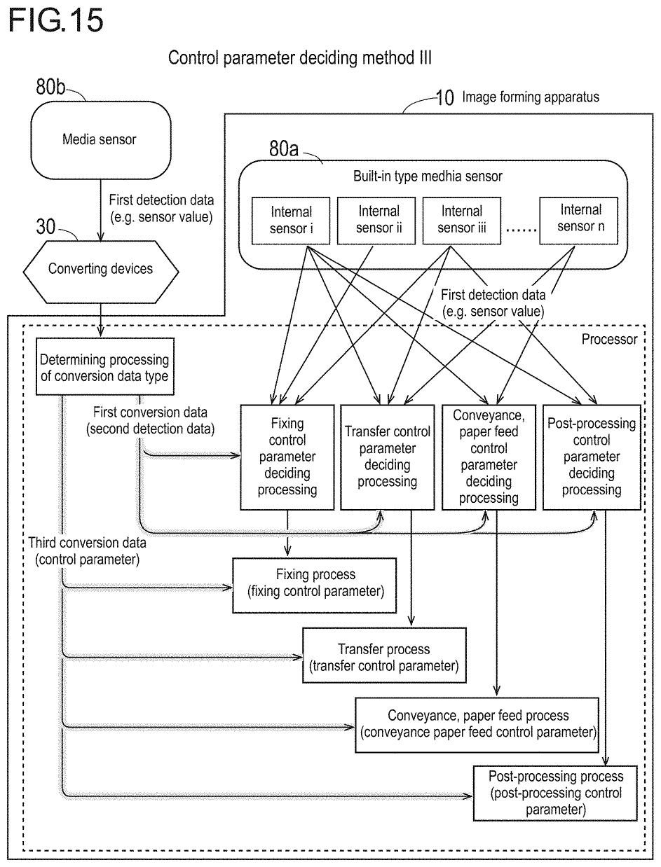

FIG. 15 is a schematic diagram showing the control parameter deciding method III. In the control parameter deciding method II, after having classified once into the paper type and the basic weight, the control parameter is decided. However, in this control parameter deciding method III, each control parameter is directly decided from the detection data of the paper physical properties. For example, the processor of the image forming apparatus 10 decides a fixing control parameter from the detection data of the internal sensors 1 to 3, and decides a transfer control parameter from the detection data of the internal sensors 1, 3 and n. In this connection, when deciding this control parameter, the image forming apparatus 10 for converting device 30) may use a learned model having been learned with machine learning.

In the case where the converting device 30 outputs the first conversion data with the identification code, the converting device 30 recognizes the Type of the media sensor 80 interlocking with the image forming apparatus 10, for example, the Type of the built-in media sensor 80. Then, on the basis of a difference in the type and performance of the internal sensors of the media sensor 80, the converting device 30 performs the first converting processing for a measured value by a conversion formula or a conversion table, creates the first conversion data (the second detection data), and outputs it to the image forming apparatus 10 and so on. The image forming apparatus 10 decides each control parameter by using this.

Moreover, in the case of outputting the third conversion data with the identification code, the converting device 30 recognizes the Type of the image forming apparatus 10 from the identification information of the image forming apparatus 10, decides each control parameter by an algorithm matched with the Type, and outputs this to the image forming apparatus 10. The image forming apparatus 10 performs control for fixing, image formation, conveyance, and so on by using the received control parameter.

FIG. 16 is a diagram showing the decision processing corresponding to the media sensor 80 of Type3 (refer to FIG. 2) in the control parameter deciding method III. The processor of the image forming apparatus 10 performs the control parameter deciding processing for each control parameter by the processing like that shown in FIG. 16 on the basis of information on each of the internal sensors 1 to 10, a printing condition, and a status of the apparatus. Moreover, as the provision of information for a user, the processor performs determination for each of an embossed paper, a paper type, and a basic weight class and displays the determination result on an operation panel and so on. Although this determination result for each of an embossed paper, a paper type, and a basic weight class is not basically used for control of image formation etc., the determination result is provided for a user in order to make correspondence to the control parameter deciding method I and II up to the present situation.

Moreover, in the case where the converting device 30 performs the deciding processing of a control parameter, from the identification information of the image forming apparatus 10, the converting device 30 recognizes that the media sensor 80 interlocking with the image forming apparatus 10 is Type3, decides each control parameter by the algorithm matched with that Type, and outputs this to the image forming apparatus 10.

FIG. 17 is a diagram showing converting processing information (conversion table) in a combination of respective Types of a conversion source apparatus and a use destination apparatus (conversion destination apparatus) of conversion data. The converting processing information is also referred to as an association table (combination table) in below. Each conversion data indicated with a circled number in the above diagram (FIG. 17) corresponds to the conversion data indicated in the table shown in FIG. 12. In the above diagram (FIG. 17), the mark of a slash (/) is indicated with the meaning of “or”. For example, in the case where a conversion source and a conversion destination are the same “Type1” with each other, the converting processing is made to (1) “no conversion”. Moreover, in the case of from the conversion source Type1 to the conversion destination Type2, the converting processing is made to (2) data conversion 1 (UG) or to (5) discrimination data of a paper type and a basic weight class.

In this way, in the present embodiment, the converting device 30 includes an acquisitor that acquires, from the first media sensor, the first detection data constituted by measurement results of one or more paper physical properties obtained by measuring a recording medium; a convener that converts the acquired first detection data into conversion data being information on the basis of the measurement result of the second media sensor; and an output unit that outputs conversion data converted by the converter. With this, even in the case where functions or performances are different due to the reason that generations between the first and second media sensors am different, or formats are different, it becomes possible to use the detection data in the first media sensor correctly.

### EXAMPLE

(Reading-Out of Converting Processing Information and Updating Processing)

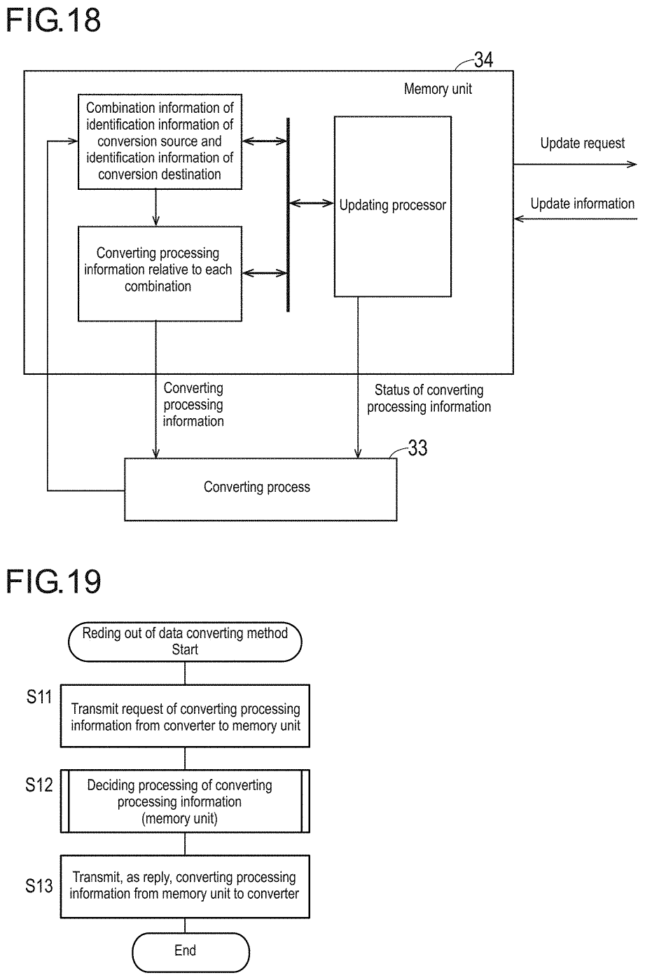

Next, reading-out of converting processing information (combination table) and updating processing are described. FIG. 18 is a block diagram showing a configuration of the memory unit 34. The memory unit 34 may include a CPU, a ROM, a RAM. FIG. 19 to FIG. 21 are flow charts showing the reading processing of a data converting method and updating processing.

(Step S11)

The converter 33 transmits combination information of identification information showing a device configuration (Type) of the media sensor 80 of a conversion source and identification information showing a device configuration of the media sensor 80 interlocking with a conversion destination (a use destination) and further transmits a request of converting processing information.

(Step S12)

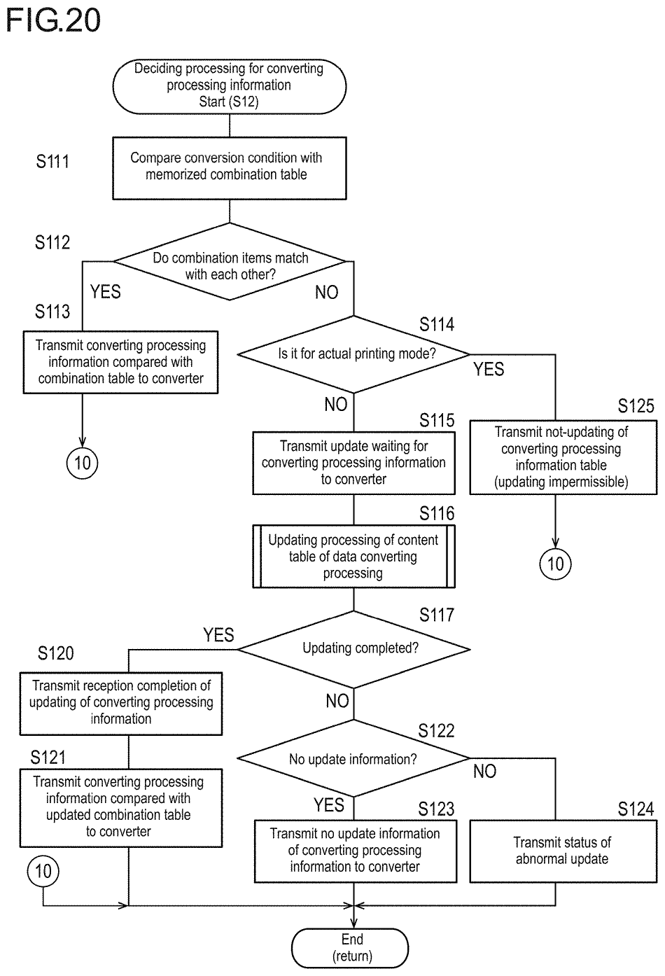

The memory unit 34 performs deciding processing of the data converting processing information. FIG. 20 is a subroutine flowchart showing the processing in Step S12 executed in the memory unit 34.

(Steps S111 and S112)

The memory unit 34 compares the memorized combination table (for example, FIG. 17) and determines whether there is a conversion condition corresponding to the combination of identification information. In the case where the combination items match with each other (YES), the processing is advanced to Step S113 or in the case where the combination items do not match (NO), the processing is advanced to Step S114.

(Step S113)

The memory unit 34 transmits the converting processing information in which the items have matched, to the converter 33, ends the processing in FIG. 20, returns to FIG. 19, and performs the processing in Step S12 and later.

(Step S114)

The memory unit 34 determines whether or not this data conversion is for an actual printing mode, and then, in the case of for an actual printing mode (YES), the memory unit 34 advances the processing to Step S125, otherwise (NO), the memory unit 34 advances the processing to processing to Step S115. Here, the actual printing means the final output of a print job and is executed after confirming that there is no problem in quality through undergoing the process of the printing preparing processing that performs test printing (also referred to as trial printing or temporary printing) before the actual printing.

(Step S115)

In order to secure time for performing the following updating processing, the memory unit 34 transmits waiting for updating of the converting processing information, i.e., a wait signal to the convener 33.

(Step S116)

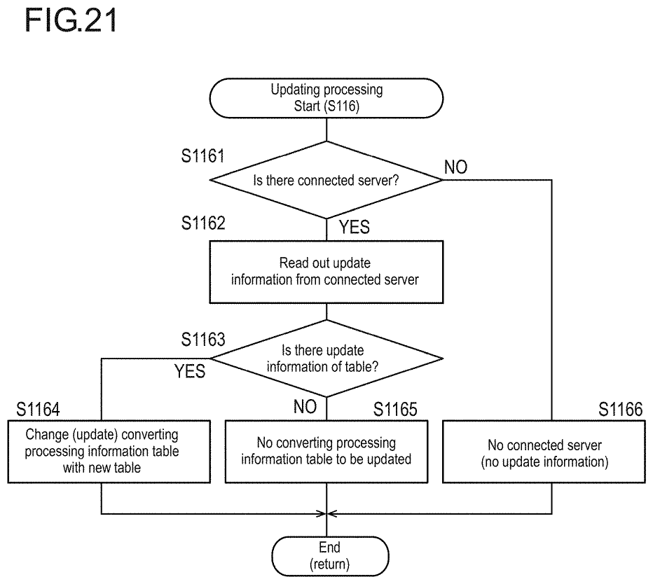

The memory unit 34 performs the updating processing of the table (combination table) of the converting processing information. FIG. 21 is a subroutine flowchart showing processing in this Step S116 to be executed in the memory unit 34.

(S1161)

Here, it is determined whether or not the converting device 30 is connected to a predetermined server, and then, in the case where the converting device 30 is connected (YES), the processing is advanced to Step S1162, and in the case where the converting device 30 is not connected (NO), processing will be advanced to Step S1166. This server is managed by, for example, a manufacturer or a sales company and distributes a table of the converting processing information updated at a predetermined time such as when a new type media sensor 80 or the image forming apparatus 10 is put on the market.

(S1162)

The memory unit 34 requires reading out of update information from the server.

(S1163)

In the case where there is the update information of the table (YES), i.e., in the case where the update information is sent from the server, the processing is advanced to Step S1164. On the other hand, in the case where then is no update information, the processing is advanced to Step S1165.

(S1164)

The memory unit 34 changes (update) the table of the memorized converting processing information and the combination table into a new table.

(S1165)

Here, since there is no converting processing information table to be updated, no particular processing is performed.

(S1166)

Here, since there is no server being connected, i.e., since there is no converting processing information to be updated, in particular, no processing is performed. Moreover, in here, a status of the purport that there is no server being connected, is transmitted. With the processing described in the above, the processing in FIG. 21 is ended, and the processing returns to FIG. 20, and the processing in Step S116 and later will be executed. In this connection, FIG. 20 and FIG. 21 each is a flowchart showing the processing for requiring updating data of the converting processing information from the apparatus side to the server side. Although not described in these charts, it is also possible to update the convening processing information table of the converting device upon receipt of a command for updating the data of the converting processing information from the server side.

(Step S117)

As shown in FIG. 20, in the case where the updating has been completed (YES), the memory unit 34 advances the processing to Step S120, and in the case of having been not completed (NO), the processing is advanced to Step S122.

(Step S120)

The memory unit 34 transmits the completion of the reception of updating of the converting processing information to the converter 33.

(Step S121)

The updated table (combination table) and the compared converting processing information are transmitted to the converter 33.

(Step S122)

In the case where there is no update information (YES), the memory unit 34 advances the processing to Step S123, otherwise (NO), the processing is advanced to Step S124.

(Step S123)

The memory unit 34 transmits a status that them is no update information of the converting processing information, to the converter 33.

(Step S124)

The memory unit 34 transmits an update abnormal status to the converter 33. With the processing described in the above, the processing in FIG. 20 is ended, and the processing returns to FIG. 19, and the processing in Step S12 and later is executed.

(Step S125)

Here, the converting processing information table is not updated (updating is impermissible). At the time of an actual printing mode, since time for updating the converting processing information table cannot be secured, in here, updating is made impermissible.

(Step S13)

As shown in FIG. 19, the memory unit 34 transmits as a reply the converting processing information to the converter 33 and ends this processing (End).

(Printing Processing on Image Forming Apparatus 10 Side)

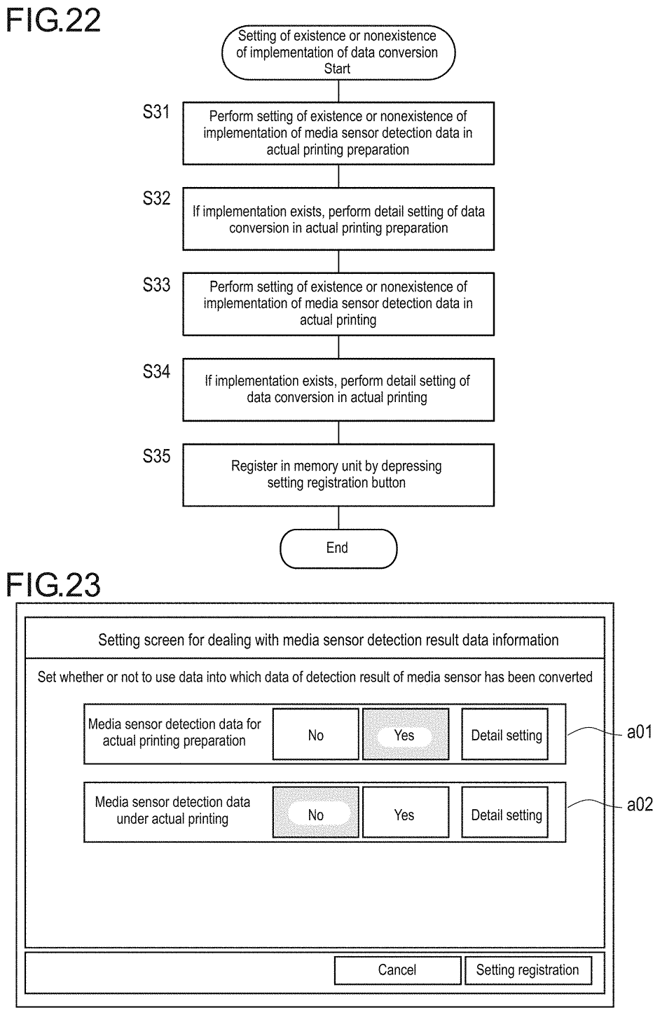

Next, with reference to from FIG. 22 to FIG. 33, the printing processing in cooperation with the media sensor 80 on the image forming apparatus 10 using the converting device 30, is described.

(Setting Cooperation with Media Sensor 8 on Converting Device 30)

First, a setting procedure for a conversion condition of detection data in the converting device 30, is described. FIG. 22 is a flowchart showing the conversion setting processing performed by the converting device 30 at the time of creating conversion data from the detection data of the media sensor 80. FIG. 23 is a drawing showing an example of a setting screen displayed on a display (operation panel) of the control device (refer to FIG. 7) of the image forming apparatus 10 and so on that controls the converting device 30.

(Step S31)

A user such as an operator in a print shop, performs setting of the existence or nonexistence of the implementation of conversion for detection data of the media sensor 80 in an actual printing preparation (trial printing) through a column a01 of the operation screen in FIG. 23.

(Step S32)

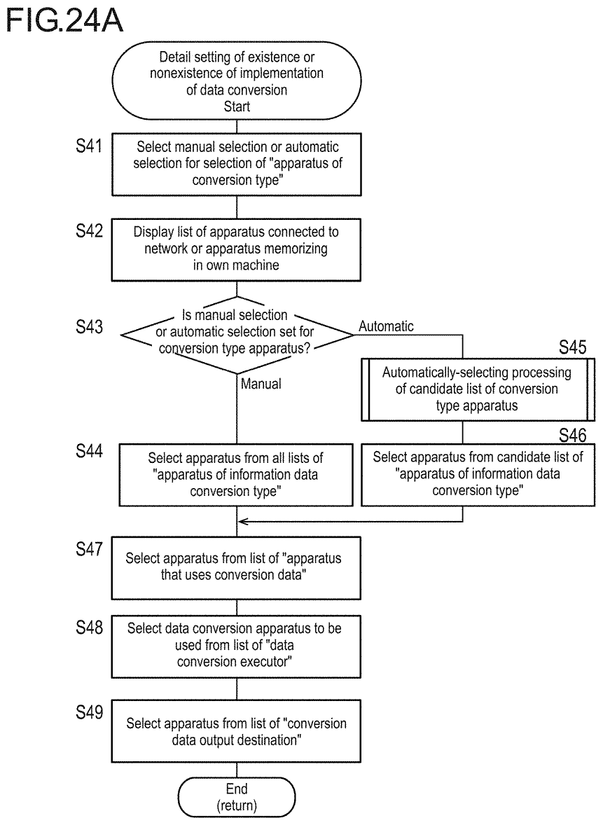

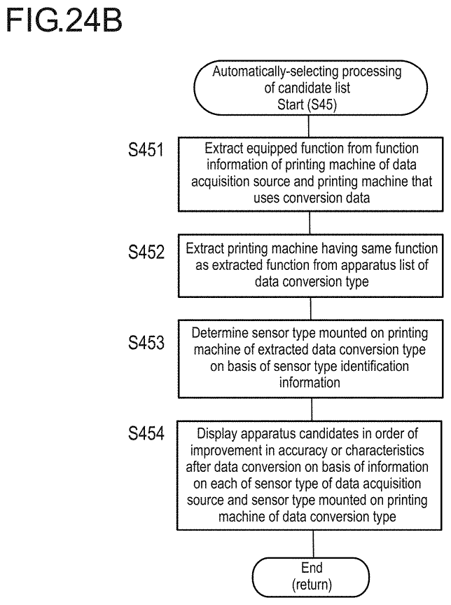

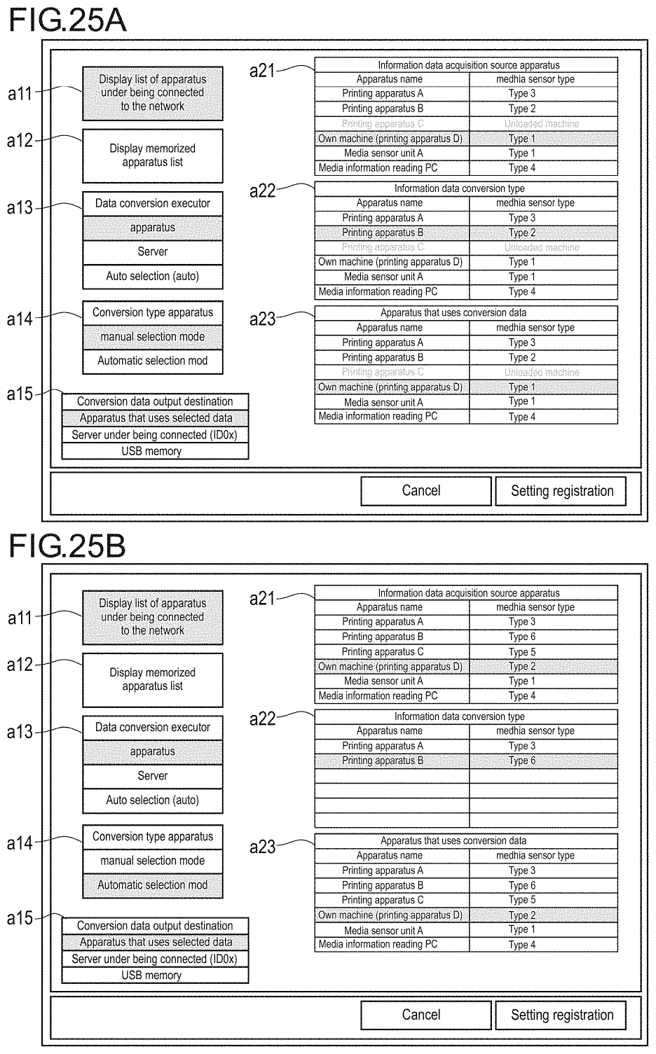

In the case of the existence of the implementation, the user can perform detail setting further. As shown in FIG. 23, in the case where the existence of the implementation (button “Yes”) has been selected, the detail setting can be performed by further depressing a button of “detail setting”. This detail setting will be described in FIG. 24A, FIG. 24B, FIG. 25A, and FIG. 25B.

(Step S33)

Moreover, the user performs setting of the existence or nonexistence of implementation of conversion for the detection data of the media sensor under actual printing through a column a02 of the operation screen.

(Step S34)

In the case of the existence of the implementation, the user can perform the detail setting further. In this connection, as shown in FIG. 23, in the case where the non-existence of the implementation (button “No”) has been selected, the processing of the detail setting is not performed.

(Step S35)

After all the settings have been finished, the settings are registered into the memory unit 34 by depressing a “setting registration” button on the operation screen.

(Detail Setting)

FIG. 24A and FIG. 24B each is a flowchart showing the detail setting processing of conversion setting and corresponds to processing in Step S32 or Step S34. FIG. 25A and FIG. 25B is a drawing showing an example of a detail setting screen displayed on a display (operation panel) of the control device of image forming apparatus 10 and so on.

(Step S41)

In the operation screen in FIG. 25A, the user can set a selection in a “conversion type apparatus” to any one of a manual selection mode and an automatic selection mode by selecting a button on a column a14.

(Step S42)

On the operation screen in FIG. 25A, the user depresses s button on a column a11. With this, the control device displays an apparatus list of apparatus connected via a cable or wirelessly to a network on columns a21 to a23. Moreover, on the apparatus list, in the case of the media sensor 80, its own Type is indicated, and in the case of the other apparatuses, the Type of the media sensor 80 being cooperated with is indicated. In this connection, by depressing a column a12, it is also possible to call up a list of apparatus have been used in the past or registered apparatuses. In this connection, “memorized apparatus list indication” on the column a12 is used to indicate the apparatus information memorized in the apparatus. In this case, an indication of “apparatus that uses conversion data” on a column a23 is limited to only a “USB memory” (due to a reason that them is an apparatus unknown whether to have been connected to a network). Accordingly, indication is compulsorily deemed as an output to a USB memory, and other selection is not displayed.

(Step S43)

The user selects an apparatus from a list of “information data acquisition source apparatus” on column a21. In an example in FIG. 25A, an own machine (printing apparatus D) is selected. In this connection, in FIG. 25A, FIG. 27, and so on, a “printing apparatus” and a “printing machine” are equivalent to the image forming apparatus 10.

(Step S44)

The user selects an apparatus from a list of all apparatuses that are displayed by the user in consideration of combination from a list of “information data conversion type” on column a22. In an example in FIG. 25A, a printing apparatus B is selected. In this connection, in FIG. 25A, in an unloaded machine in which a function is not mounted, a grayout indication is applied such that a selection cannot be performed. For example, on the printing apparatus C, the function of the converting device 30 is not mounted. Accordingly, a grayout indication is applied. As an example of an unloaded machine, there are an image firming apparatus that has been already used in the commercial market before a media sensor has been produced commercially and an image forming apparatus (for example, in the case where an image forming apparatus to be connected off-line is not connected to an off-line media sensor unit) that has not been connected with a media sensor. In an example in FIG. 17, although the description with regard to an unloaded machine 1s omitted, in the case of performing correspondence to an unloaded machine, it is possible to perform correspondence by passing a control parameter value (the third conversion data) converted by the converting device to such an unloaded machine.

(Step S45)

The processor of the own machine (printing apparatus D) performs the automatically-selecting processing of a conversion type apparatus candidate list. FIG. 24B is a subroutine flowchart showing the automatically-selecting processing in this Step S45.

(Step S451)

The processor extracts a mounted function on the basis of the data acquisition source printing machine and the functional information of a printing machine that uses conversion data.

(Step S452)

The processor extracts a printing machine with the same function as the function extracted in Step S451 from the apparatus list of a data conversion type.

(Step S453)

The processor determines a sensor type mounted on the printing machine of the data conversion type extracted in Step S452 on the basis of the sensor type identification information.

(Step S454)

The processor displays a candidate list of apparatuses in order of improvement in accuracy or characteristics after data conversion on the basis of information on a sensor type of a data acquisition source and a sensor type mounted (local connection) on a printing machine of the data conversion type. FIG. 25B is a drawing showing an example in which a candidate list (column a22) is indicated automatically by the processor in the case where the automatic setting (a14 column) is selected. With the above, the processing in FIG. 24B is ended, and the processing returns to FIG. 24A, and the processing in step S46 and later is continued. In this connection, as shown in FIG. 25B, in the case where automatic setting is selected, in order to select a candidate from printing apparatuses, a PC and a media sensor unit are not extracted as a candidate. In the case of selecting these, the user selects a manual setting mode.

(Step S46)

The user selects an apparatus from the displayed candidate list (column a22) of “apparatuses of an information data conversion type”. In an example in FIG. 25B, the printing apparatus B is selected. In the case where the user does not select a candidate, a candidate indicated at the uppermost position is selected as an apparatus of the information data conversion type, and the conversion is performed.

(Step S47)

The user selects an apparatus from a list (column a23) of “apparatus that use conversion data”. In an example in FIG. 25B, the own machine 1s selected.

(Step S48)

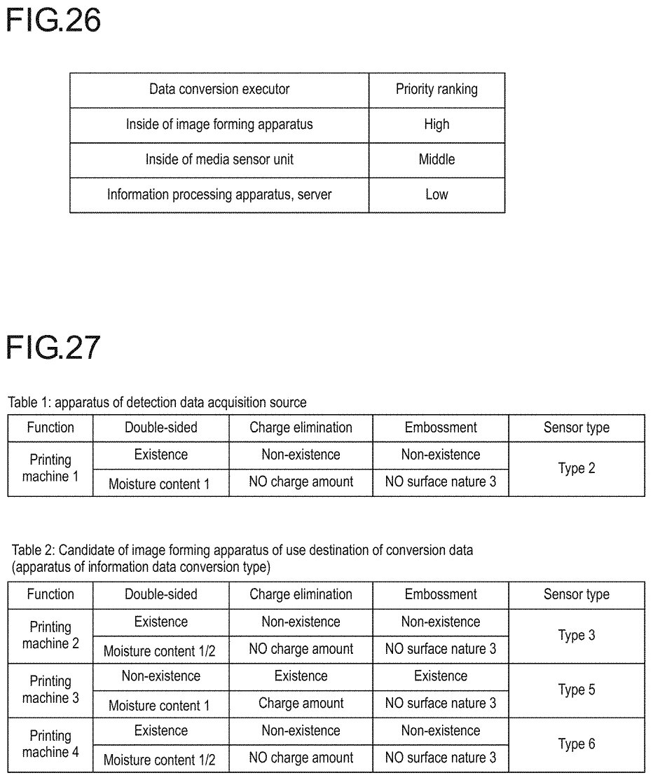

Next, the user selects a data converting device 30 to be used from a list of “data conversion executor” shown in the column a13. The selection can be set to any me of apparatus, server, and auto selection (auto). In the case of having set to automatic selection (auto), a converting device is selected depending on the length of time allowed to reflect conversion data. As shown in FIG. 26, as the priority ranking in automatic selection, in order from high priority, the inside of the image forming apparatus 10, the inside of a-media sensor unit, and an information processing device and a server are cited. In the case of being not connected to a server through a network, the selection of a server is made grey-out so that a serve cannot be selected.

(Step S49)

The user selects an apparatus from a list of “conversion data output destination” on a column a15. In an example in FIG. 25B, “apparatus that uses selected data” is selected. In this connection, in the case of not being connected to a network, as an output destination, a USB memory being locally connected to the own machine 1s unconditionally selected. After the user has selected all the settings, by depressing a “setting registration” button, the setting has been completed.

In an example in FIG. 25A and FIG. 25B, from a list of apparatus under being connected to the network, data acquisition source (own machine), data conversion type, apparatus (own machine) that uses conversion data are selected, and this selection is secured by setting of moving data via a network. Actually, reading-in of paper physical properties by the media sensor 80, data conversion, and reflection of conversion data are performed in the sequence of a reading operation of the media sensor 80. For example, in the case of having read a paper by the media sensor 80 at a predetermined timing, data conversion is performed and conversion data is output in accordance with the contents set on the above media sensor cooperation screen (FIG. 23, FIG. 25A, etc.). Successively, the apparatus that uses data, decides a control parameter by using the output conversion data. As this predetermined timing, (1) a timing when having read the physical properties of a paper in the paper setting by the media sensor 80, (2) a timing when having read the physical properties of a paper by the media sensor 80 for each time of feeding a paper under printing, (3) a timing when having read the physical properties of a paper by the media sensor 80 before printing a reverse surface after having passed the fixing process, and so on, may be cited.

As described in the above, in the case of executing data conversion by deciding (setting) a conversion condition with a converting device mounted on an apparatus, upon selecting an apparatus from a list (column a13) of the data conversion executor, apparatuses being connected to a network are indicated on columns a21 to a23. In the case where the own machine (printing machine D) performs printing, the printing is performed by changing the control parameter of the own machine by using data convened from the paper physical property measurement data of a recording medium acquired by the own machine into a result having been measured by the improved sensor type “Type2” whose accuracy has been improved. For such a purpose, from a list of apparatuses under being connected with a network, the own machine (printing apparatus D) equipped with the sensor type “Type1” is selected as the data acquisition source, the printing machine B equipped with the sensor type “Type2” is selected as the type of data conversion, and the own machine (printing apparatus D) is selected as the output destination of conversion data, and then, the setting registration is performed. By deciding the control parameter from the conversion data in which data conversion of this combination has been performed, it is possible to perform printing on the basis of the control parameter more suitable for a recording medium.

Moreover, in the example (FIG. 25A and FIG. 25B) of “media sensor cooperation screen”, an indication of “apparatus of an information data conversion type” is provided fir selection by the user. However, in the case of having selected “automatic” in which there is no need for an operator (user) to set, the apparatus side (processor) selects automatically, and the selected apparatus information is displayed. Furthermore, in the case of selecting automatically, the indication of “apparatus of an information data conversion type” (column a22) may be made not to be displayed.

(Conversion to Information on Basis of Detection Result of Second and Third Media Sensor 80)

Next, description is given to an example in which, according to the function of the image forming apparatus 10 that uses converted information, the detection data of the first media sensor 80 is converted into one of the information based on the detection result in the second media sensor 80 and the information based on the detection result in the third media sensor 80.

FIG. 27 is a drawing for describing an example to convert into any one of the second and third media sensors. In Table 1 (also the same for Table 2), in “Double-sided” at a left column, the existence or nonexistence of a double-sided printing function and the existence or nonexistence of the internal sensor 6 (moisture content 1) or the internal sensor 7 (moisture content 2) each of which measures the paper physical properties corresponding to this, are indicated. In “Charge elimination” at a center column, the existence or nonexistence of an electric charge eliminating function relative to a paper surface under conveyance and the existence or nonexistence of an internal sensor 10 (charge amount) that measures the corresponding paper physical properties, are indicated. In “Embossment” at a right column, the existence or nonexistence of correspondence for printing an embossed paper and the existence or nonexistence of an internal sensor 5 (surface nature 3) that measures the paper physical properties corresponding to this, are indicated. In this connection, the printing machine 1 in FIG. 27 corresponds to the own machine and the printing apparatus D in FIG. 25B, the printing machine 2 corresponds to the printing apparatus A, the printing machine 3 corresponds to the printing apparatus C, and the printing machine 4 corresponds to the printing apparatus B, respectively.

In an example in Table 1, the media sensor 80 mounted on the printing machine 1 of the acquisition source of detection data is Type 2 and acquires the data of paper physical properties by its internal sensors.

In an example in Table 2, from a relation with the printing machine 1 in Table 1, an image forming apparatus that converts or an information data conversion type apparatus is an apparatus for which the printing machine 2 (Type 3) or the printing machine 4 (Type 6) becomes as a candidate. Since a double-side printing function of each of the printing machines 2 and 4 is common to that of the printing machine 1, these printing machines 2 and 4 can be selected. Although the printing machine 3 has a charge eliminating function and an embossment function, since the printing machine 1 of the acquisition source is not equipped with these functions, the printing machine 3 may be excluded from a candidate. That is, since it is not a printing machine having the same function, it is excluded from a candidate (FIG. 24B).

The setting of the designation information of the conversion data of this printing machine is performed by a “designation condition determining algorithm” incorporated in the converting device 30 itself or a control device that controls this. The determination condition selects apparatus information of a condition on which conversion results become the same, from the identification information (identification information A) indicating a configuration (Type) of the media sensor 80 of an acquisition source and the identification information (identification information B) of an apparatus that uses conversion data. For example, in the case where the apparatus that uses conversion data is the image forming apparatus 10, the designation condition determining algorithm can discriminates, from the identification information B, the function information (both surfaces, charge elimination, correspondence to embossment, etc.) that this image forming apparatus 10 has and the Type information on a media sensor that this image forming apparatus 10 corresponds to, by referring to the memorized data base.

(Printing Processing)

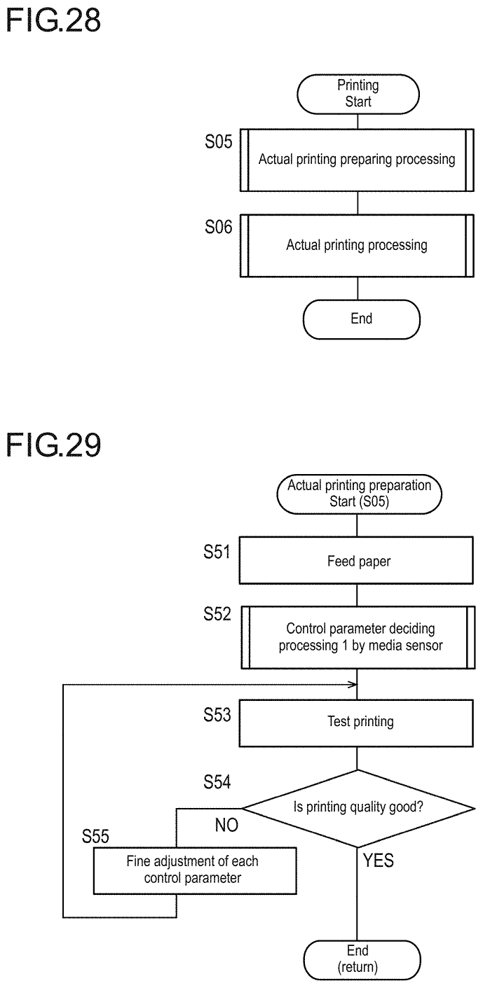

Next, with reference to from FIG. 28 to FIG. 33, the printing processing in the image firming apparatus 10 is described. FIG. 28 is a flowchart showing printing processing.

(Step S05)

The image forming apparatus 10 executes an actual printing preparing processing. This processing will be described in the subroutine flowchart shown in FIG. 29.

(Step S06)

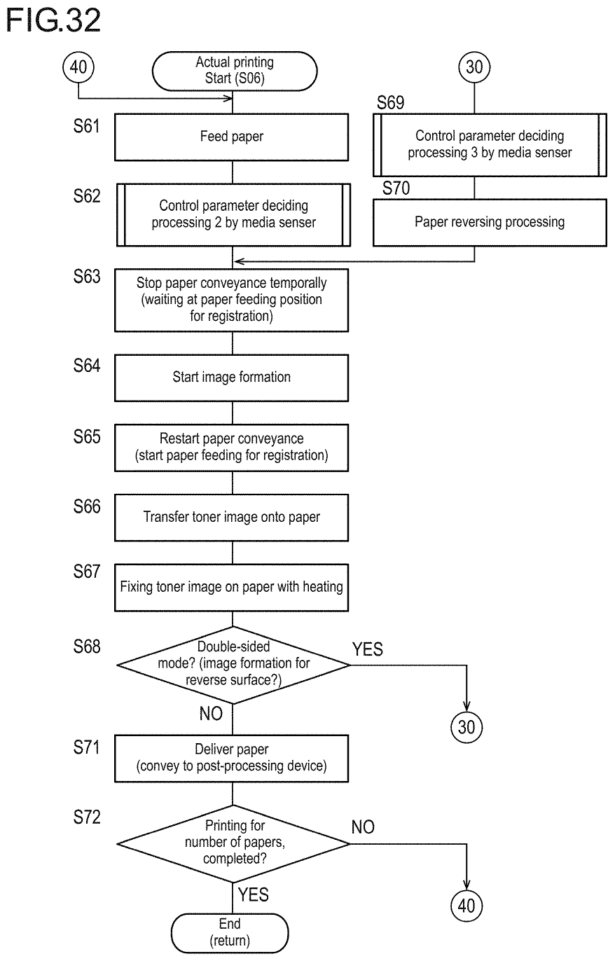

The image forming apparatus 10 executes actual printing processing on the basis of the setting condition set in Step S05. This processing will be described in the subroutine flowchart shown in FIG. 32.

(Actual Printing Preparing Processing (S05))

(Step S51)

As shown in FIG. 29, in the present step, the feeding and conveyance of a paper from the paper feed tray of image forming apparatus 10 are performed. Alternatively, in the case of using the external media sensor 80 (80a or 80b), a paper is fed to the measurement point of the media sensor 80 by a manual manner and the like.

(Step S52)

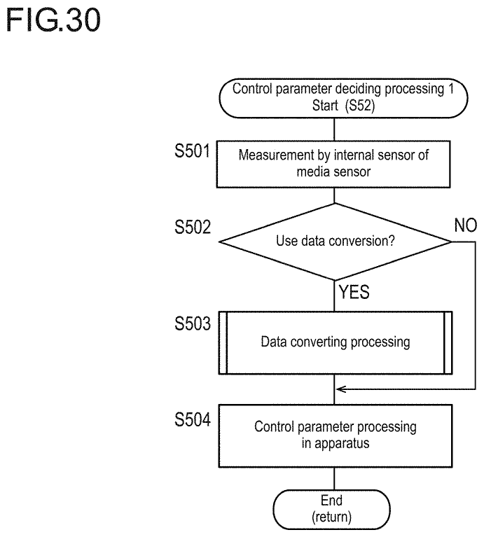

The image forming apparatus 10 or the converting device 30 performs the control parameter deciding processing 1 by the detection data of the media sensor 80. The deciding processing 1 is mentioned later in FIG. 30.

(Step S53)

With the control parameters set in Step S52, the image forming apparatus 10 performs test printing to form an image onto a paper.

(Step S54)

The user checks quality by visually confirming the test printing or by referring to the measurement result of an external measurement instrument etc., and then, in the case where quality is good (YES), the user ends the processing in the subroutine in FIG. 29, returns to FIG. 28, and performs the processing in Step S5 and later. On the other hand, in the case where quality is not good (NO), the processing is advanced to Step S55.

(Step S55)

Here, the user performs fine adjustment for each control parameter. This fine adjustment is performed, for example, through the setting screen of the operation panel of the image forming apparatus 10. Hereinafter, the processing is made to return to Step S53, and the processing in the steps of the test printing and later is repeated.

(Subroutine Processing of Control Parameter Deciding Processing 1 (Step S52))

FIG. 30 is a subroutine flowchart showing the control parameter deciding processing 1 in Step S52 in FIG. 29.

(Control Parameter Deciding Processing 1)

(Step S501)

A paper is measured by the internal sensor of the media sensor 80 built in the image forming apparatus 10 or other media sensor 80 other than this, thereby obtaining the first detection data.

(Step S502)

In the case of performing data conversion by using the converting device 30 (YES), the processing is advanced to Step S503. On the other hand, in the case where the data conversion is not needed due to the measurement performed with the built-in media sensor 80 etc. (NO), Step S503 is skipped.

(Step S503)

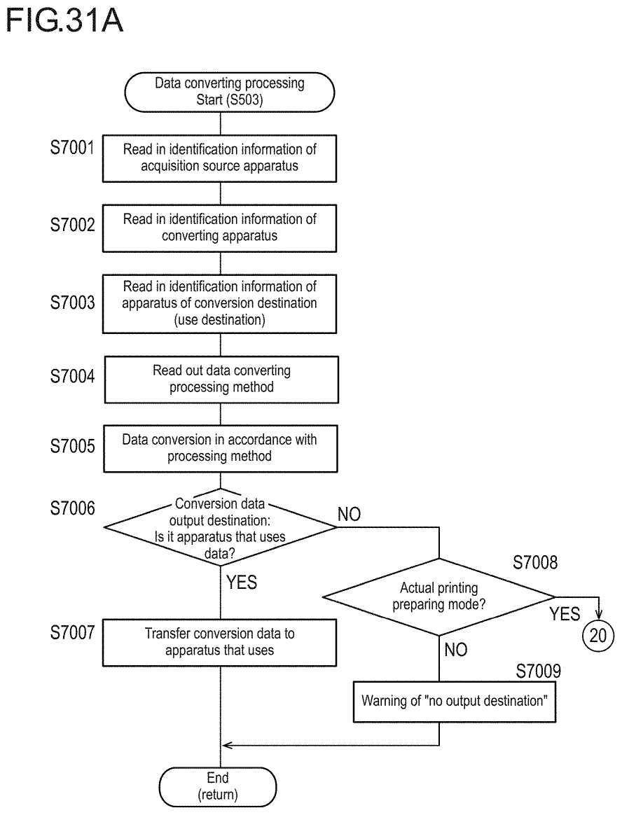

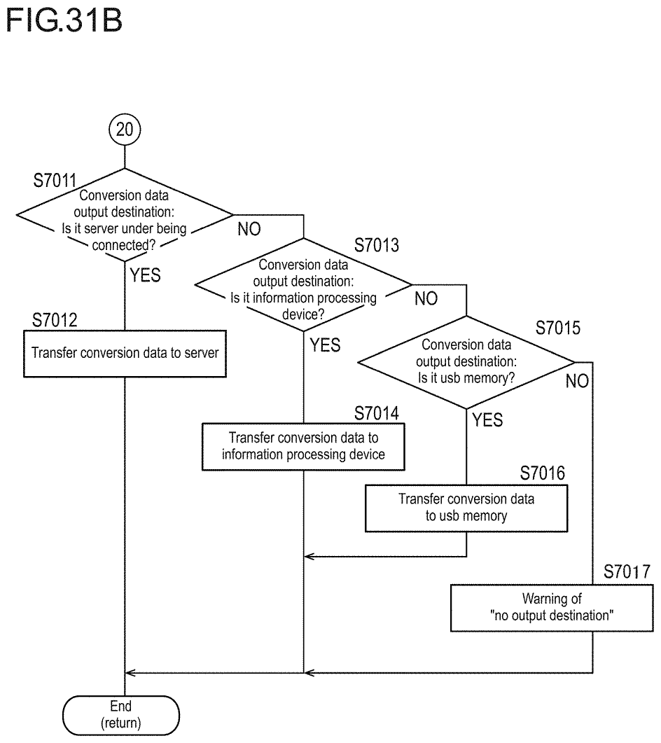

The converting device 30 performs data converting processing. FIG. 31A and FIG. 31B are subroutine flowcharts showing the data converting processing in Step S503.

(Data Converting Processing)

(Steps S7001 to S7003)

The converting device 30 performs reading in of the identification information showing the configuration of an acquisition source apparatus, a converting device, and a conversion destination apparatus. This reading-in acquires from, for example, each apparatus being connected to the network.

(Step S7004)

The converting device 30 performs reading out of a data converting processing method. For example, the data converting processing method is read out from the convening processing information (refer to FIG. 17) memorized in the memory unit 34.

(Step S7005)

The convener 33 of the convening device 30 performs converting processing for the first detection data obtained by measurement of the media sensor 80 and acquired in Step S501 (or Step S601) in accordance with the data converting processing method.

(Step S7006)

In the case where the conversion data output destination is an apparatus that uses data, for example, the image forming apparatus 10 (YES), the convening device 30 advances the processing to Step S7007, otherwise (NO), advance the processing to Step S7008.

(Step S7007)

The output unit 35 of the converting device 30 outputs the conversion data created in Step S7005 to the apparatus that uses data.

(Step S7008)

In the case of being not an actual printing preparation mode (NO), i.e., being an actual printing mode, the converting device 30 advances the processing to Step S7009. On the other hand, in the case of being an actual printing preparation mode (YES), the processing is advanced to Step S7011 in FIG. 31B.

(Step S7009)

The convening device 30 returns a warning status of no output destination.

(Step S7011)

At this step, as shown in FIG. 31B, in the case where a conversion data output destination is a server under being connected (YES), the converting device 30 advances the processing to Step S7012, otherwise (NO), advances the processing to Step S7013.

(Step S7012)

The converting device 30 transfers the conversion data to the server.

(Step S7013)

In the case where the conversion data output destination is an information processing device (YES), the converting device 30 advances the processing to Step S7014, otherwise (NO), advances the processing to Step S7015.

(Step S7014)

The converting device 30 transfers the conversion data to the information processing device.

(Step S7015)

In the case where the conversion data output destination is a USB memory (YES), the convening device 30 advances the processing to Step S7016, otherwise (NO), advances the processing to Step S7017.

(Step S7016)

The converting device 30 transfers the conversion data to the USB memory being connected to the main body.

(Step S7017)

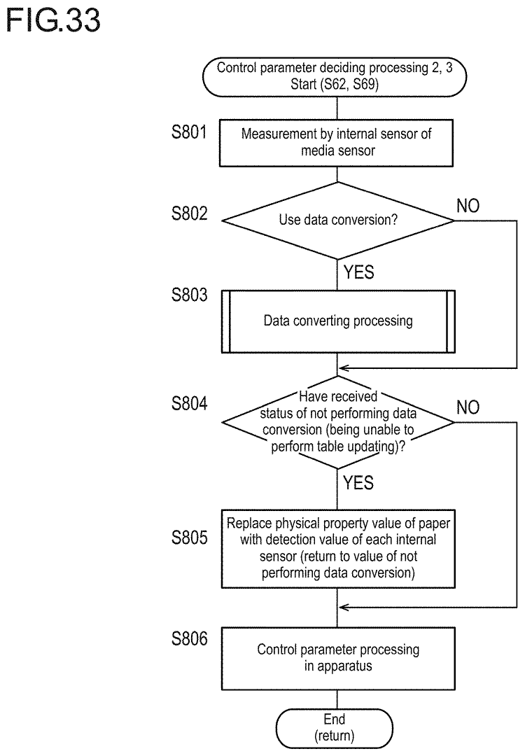

The converting device 30 returns a warning status of no output destination. With the above, the subroutine processing with regard to the data converting processing in FIGS. 31A and 33B is ended, the processing returns to FIG. 30, and the processing in Step S503 and later is executed.

(Step S504)

FIG. 30 is referred to again. Here, the image forming apparatus 10 decides a control parameter on the basis of the conversion data obtained by the data converting processing. In the case where the conversion data created by the converting device 30 is the third conversion data (control parameter), the image forming apparatus 10 uses the third conversion data as it is.

In the case where the conversion data created by the converting device 30 is the first conversion data (conversion value) or the second conversion data (data used for setting a control parameter (a paper type, a basic weight class)), the image forming apparatus 10 decides a control parameter on the basis of this conversion data by the processing as shown in FIG. 11A or FIG. 15. With the above, the subroutine flowchart in FIG. 30 is ended, the processing returns to FIG. 29, and the processing in Step S52 and later is executed.

(Actual Printing (Step S06))

(Step S61)

As shown in FIG. 32, in the present step, paper feed conveyance of a paper from the paper feed tray of the image forming apparatus 10 is performed.

(Step S62)

The image forming apparatus 10 or the converting device 30 executes the control parameter deciding processing 2 on the basis of the first detection data obtained by measurement of the media sensor 80 built in the image forming apparatus 10. This deciding processing 2 and the below-mentioned deciding processing 3 are later mentioned with reference to FIG. 33.

(Step S63)

The image forming apparatus 10 stops paper conveyance temporarily and makes a paper wait at a paper feed registration position (position of a registration roller) on the upstream side of the transfer position.

(Step S64)

The image forming apparatus 10 starts image formation on the basis of the control parameter decided in Step S62.

(Steps S65 to S67)

The image forming apparatus 10 restarts the temporarily-stopped paper conveyance and performs toner image transfer to a paper and fixing processing, thereby forming an image on a paper.

(Step S68)

In the case where the printing under execution is a double-sided mode (YES), the image forming apparatus 10 advances the processing to Step S69, in the case of being not a double-sided mode (NO), the processing is advanced to Step S71.

(Step S69)

The image forming apparatus 10 or the converting device 30 executes the control parameter deciding processing 3 on the basis of the detection data of the media sensor 80 built in the image forming apparatus 10. The control parameter decided by this deciding processing 3 is used in image formation (the next Step S64) for the second surface (reverse surface) of the double-sided surfaces.

(Step S70)

The image forming apparatus 10 performs paper reversing processing to reverse obverse and reverse surfaces of a paper on a switchback conveyance path, conveys the paper to the paper feed registration position again, repeats the processing in Step S63 and later, and performs image forming processing to the reverse surface of the paper.

(Step S71)

After the image formation for one side surface finishes in the single side mode, or after the image formation for double-sided surfaces finishes in the double-sided mode, the image forming apparatus 10 delivers the paper.

(Step S72)

In the case where the printing for a number of papers set in the print job has not been completed (NO), the image forming apparatus 10 repeats the processing in Step S61 and later. On the other hand, in the case where the printing for a number of papers has been completed (YES), the printing processing is ended (END).

(Control Parameter Deciding Processing 2 and 3)

(Step S801)

Measurement is performed for a paper by the media sensor 80 built in the image forming apparatus 10.

(Step S802)

The image forming apparatus 10 determines whether or not the setting is made to use data conversion. This setting is one set on the operation screen in FIG. 23 by the processing in FIG. 22. In the case of using data conversion (YES), the processing is advanced to Step S803, and in the case of not using data conversion (NO), Step S803 will be skipped.

(Step S803)

Here, the converting device 30 performs data conversion. Here, processing described in FIG. 31A and FIG. 31B is performed.

(Step S804)

In the case of receiving a status of “not performing data conversion” (YES), the image forming apparatus 10 advances the processing to Step S805, otherwise (NO), advances the processing to Step S606. The status, here, of “not performing data conversion” is the status created in Step S125 in FIG. 20. For example, it is a case of giving up data conversion because of relations, such as processing time of the updating processing of the converting processing information (table).

(Step S805)

Since data conversion was not able to be performed, the image forming apparatus 10 replaces the detection data in Step S801 with the detection value of the paper physical properties detected by each of the original internal sensors.

(Step S806)

Here, the image forming apparatus 10 decides a control parameter on the basis of the conversion data obtained by the data converting processing or the detection data (the first detection data) obtained by the measurement in Step S801. With the above, the subroutine processing in FIG. 33 is ended, and the processing returns to the original processing in Step S62 in FIG. 32, or Step S69, and the subsequent processing is executed.

(Machine Configuration of Image Forming Apparatus 10, Paper Conveying Device 20, and Media Sensor 80)

Hereafter, with reference to from FIG. 34 to FIG. 39, the machine configuration of the image forming apparatus 10, the paper conveying device 20, and the media sensor 80 is described. The media sensor 80 described in these drawings is equivalent to Type1 (refer to FIG. 2). In each of the drawings, an up-and-down direction is referred to as a Z direction, a front face to back face direction in an image forming apparatus is referred to as a X direction, and a direction orthogonal to each of these X and Z directions is referred to as a Y direction. The X direction is also referred to as a width direction.

FIG. 34 is a drawing showing a schematic configuration of the image forming apparatus 10 equipped with the built-in media sensor 80a. The image forming apparatus 10 includes a processor 11, a memory 12, an image former 13, a paper feed conveyor 14, an operation panel 15, a communicator (not shown), a media sensor 80a, and so on. The processor 11 includes a CPU, a ROM, a RAM, etc., executes various types of processing by executing programs stored in the ROM and the memory 12, and performs control for each unit of the apparatus and various types of arithmetic processing in accordance with the programs.

The image former 13 forms an image by, for example, an electro-photographing method. As shown in FIG. 34, the image former 13 includes writers 131 corresponding to respective basic colors of Y (yellow), M (magenta), C (cyanogen), and K (black), photoconductor drums 132, and developers 133 each of which stores one of two-component developing agents each including toner of one of the basic colors and carrier. Moreover, the image former 13 further includes an intermediate transfer belt 134, a secondary transferer 135, and a fixer 136. Toner images formed on the photoconductor drums 132 by the respective developers 133 of the basic colors are superimposed on each other on the intermediate transfer belt 134, and then, the superimposed toner images are transferred onto a conveyed paper 300 at a transfer position of the secondary transferer 135. The superimposed toner images on the paper 300 are heated and pressurized by the fixer 136 on the downstream side, whereby the superimposed toner images are fixed as a color image on the paper 300.

The paper feed conveyor 14 conveys a paper 300 fed out from the paper feed tray 141 and so on. In the case of performing double-sided printing that further forms an image on a reverse surface of a paper 300, the paper feed conveyor 14 conveys a paper 300 with an obverse surface on which an image has been formed, to a conveyance path 144 that is located on a lower portion of an apparatus main body and used for double-sided image formation. A paper 300 having been conveyed to this conveyance path 144 is subjected to an obverse/reverse surface reversing process on a switchback route. After obverse/reverse surfaces of the paper 300 are reversed on the switchback route, the paper 300 is conveyed so as to join the conveyance flow of the conveyance path 143 so that an image is formed on the revere surface of the paper 300 by the image former 13. The paper 300 onto which image formation has been performed is discharged onto a paper delivery tray 145.

The processor 11 controls image formation by the image former and/or conveyance of a recording medium by the conveyor and/or post processing on the basis of each control parameter decided by the control parameter deciding processing. For example, the processor 11 controls the paper feed conveyor 14, the secondary transferer 135, and the fixer 136 on the basis of the decided control parameters.

FIG. 35 is a side view showing a configuration of the built-in type media sensor 80a disposed on a conveyance path 143. The media sensor 80a includes a paper thickness detector 40, a basic weight detector 50, a surface nature detector 60, and a paper pressing mechanism 70, and measures a plurality of paper physical properties. This basic weight detector 50 is a first optical sensor of a transmission type and the surface nature detector 60 is a second optical sensor of a reflection type. When detecting paper physical properties by the surface nature detector 60, the paper pressing mechanism 70 depresses down a paper.

As shown in FIG. 35, among these configuration components, on the upstream side of the conveyance direction, there is provided the paper thickness detector 40, and on the downstream side, there ae provided the basic weight detector 50, the surface nature detector 60, and the paper pressing mechanism 70. The basic weight detector 50 and the surface nature detector 60 are disposed side by side along a width direction (an X direction) at the same position in the conveyance direction. For example, the basic weight detector 50 is disposed on the front side, and the surface nature detector 60 is disposed on the back side. On an upper side of the conveyance path 143 configured between the upper guide plate 182 and the lower guide plate 181, the surface nature detector 60 is disposed, and on a lower side, the paper pressing mechanism 70 is disposed so as to oppose to the surface nature detector 60. On the conveyance path 143, there are provided the conveyance roller pairs 41, 186, and 187 sequentially from the upstream side.

(Paper Thickness Detector 40)

When a paper 300 is conveyed to a nipped portion between the conveyance roller pair 41 in the paper thickness detector 40, a shaft position of a driven roller of the conveyance roller pair 41 is displaced correspondingly to the thickness of the paper 300. At this time, the paper thickness detector 40 measures the thickness of the paper 300 by measuring the height of this displaced shaft. In the conveyance roller pair 41, a lower-side roller of the two rollers is a fixed drive roller (the shaft center is fixed), and an upper-side roller is a driven roller that is urged separably toward the drive roller. The height of the upper roller is detected by a displacement sensor. The displacement sensor includes an actuator (detection lever) configured to come in contact with an upper roller shaft and an encoder to measure the amount of rotation of this actuator. From the paper thickness detector 40, for example, a paper thickness (micron) is output as a measurement result of paper physical property 3 (paper thickness).

(Basic Weight Detector 50)

The basic weight detector 50 is a transmission type optical sensor that detects a physical property value corresponding to the basic weight of a paper 300, includes a light emitting element disposed below the conveyance path 143 and a light receiving element disposed above it, and measures the amount of attenuation (transmittance) of light having penetrated a paper 300. From the basic weight detector 50, for example, the transmittance is output as a measurement result of the paper physical property 2 (basic weight).

(Surface Nature Detector 60)

The surface nature detector 60 includes a housing, a light emitting element, a collimate lens, and a plurality of light receiving elements and as described below, detects optically specularly-reflected light and diffusely-reflected light from the surface of a paper. The upper guide plate 182 is provided with an opening portion (measurement region), and this opening portion becomes an irradiation area of the light receiving element. A paper 300 having been conveyed up to the opening portion is temporarily stopped. The paper 300 is pressed, in the stopped state, from the lower side by the paper pressing mechanism 70 and is subjected to positioning. A reference plane in the opening portion is a virtual plane including an undersurface of the upper guide plate 182, and at the time of measurement, on the reference plane, the surface of the paper 300 that is an object to be measured and has been subjected the positioning, is disposed. An irradiation light flux made to a parallel light flux by a collimate lens is irradiated from the light emitting element with an incident angle of 75 degrees relative to the reference plane. A wavelength of the irradiation light, for example, is 465 nm. The plurality of light receiving elements receive specularly-reflected light and diffusely-reflected light. For example, the light receiving elements are arranged at three places for reflection angles of 30 degrees (for diffusely-reflected light), 60 degrees (for diffusely-reflected light), and 75 degrees (for specularly-reflected light) or at two places for reflection angles of 60 degrees and 75 degrees. From the surface nature detector 60, signals of these light receiving elements are output as a measurement result of the paper physical property 1 (surface nature 1/smoothness).

(Paper Pressing Mechanism 70)

This paper pressing mechanism 70 is disposed below the lower guide plate 181. The paper pressing mechanism 70 includes a pressing portion, a drive motor, a cam mechanism, and the like. The top surface of the pressing portion moves upward and downward by the drive of the drive motor and is a flat surface parallel to the lower guide plate 181. At the time of normal paper conveyance, the top surface of the pressing portion is positioned at the same level as the lower guide plate 181. However, at the time of measurement, the top surface of the pressing portion moves upward and pushes a paper 300 against the surface nature detector 60 side. In the state of having pushed the paper 300, the conveyance of the paper 300 is being stopped.

(Paper Conveying Device 20)

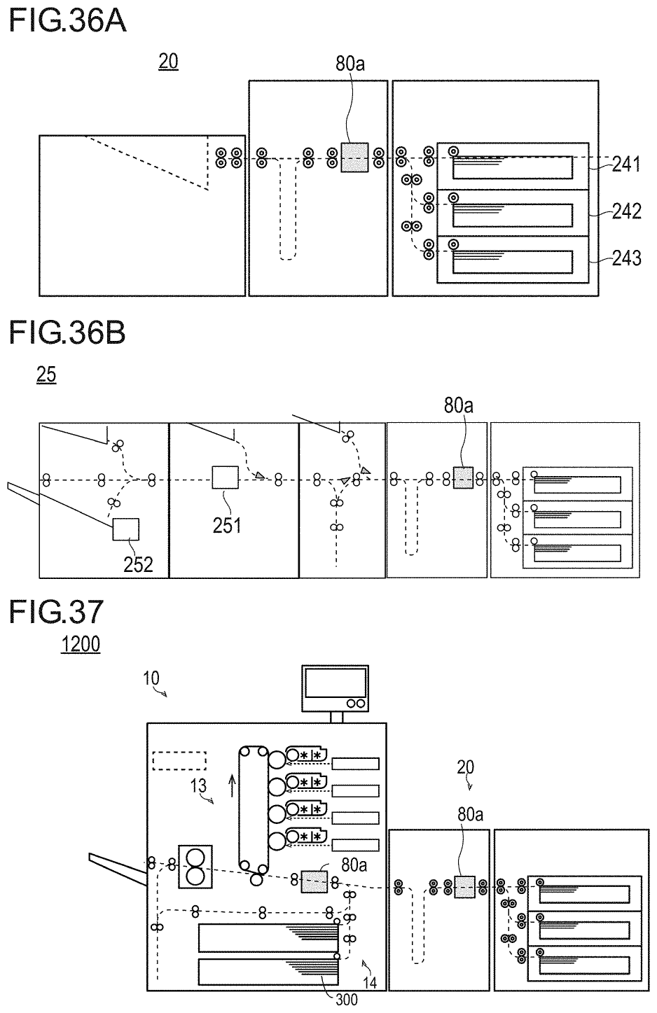

FIG. 36A is a drawing showing a schematic configuration of the paper conveying device 20 equipped with the built-in media sensor 80a. The paper conveying device has a similar function with the paper feed conveyor 14 of the image forming apparatus 10 and sets various standard fixed size papers, such as an A3 size paper or a long paper with a length of 1300 mm into a plurality of paper feed trays 241 to 243. Moreover, papers are automatically fed from these paper feed trays, and paper physical properties are measured by the built-in media sensor 80.

(Post Processing Device 25)

FIG. 36B is a drawing showing a schematic configuration of the post processing device 25 equipped with the built-in media sensor 80a. The post processing device 25 includes a post processors 251 and 252 and applies post processing to a printed paper on which an image has been formed by the image forming apparatus 10 and so on. The post processing executed by the post processors 251 and 252 includes at least one of punching processing, stapling processing, cutting processing, folding processing, perforating processing, and bookbinding processing.

(Media Detecting System 1200)

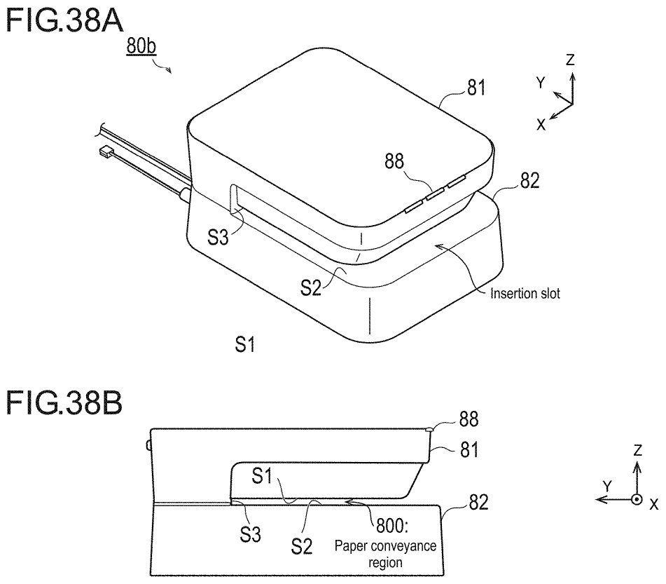

FIG. 37 is a drawing showing a schematic configuration of a media detecting system 1200 including an image forming system equipped with the image forming apparatus 10 and the paper conveying device 20. Even in such a media detecting system 1200, paper physical proper ties can be measured by the built-in type media sensor 80a.

(External Media Sensor 80b)

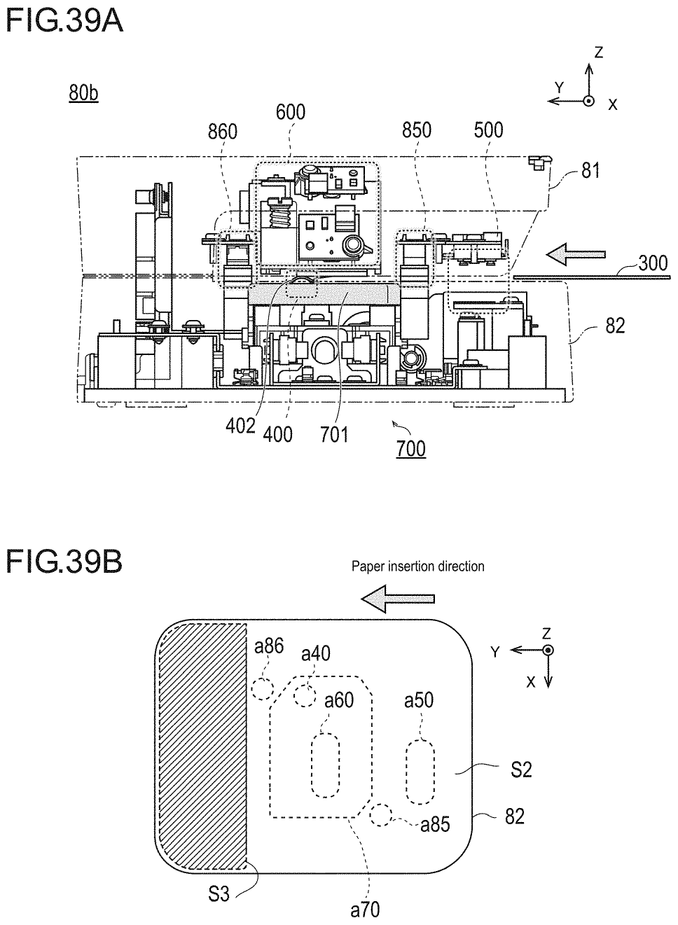

Next, with reference to FIGS. 38A and 38B and FIGS. 39A and 39B, the configuration of the external media sensor 80b is described. FIG. 38A is a perspective view, FIG. 38B is a side view, and each of FIG. 38A and FIG. 38B shows an appearance of the external media sensor. FIG. 39A is a side view of the external media sensor 80b, and FIG. 39B is a schematic top view showing a detection region etc, in a lower housing.

As shown in FIGS. 38A and 38B, the media sensor 80b includes the upper housing 81 and the lower housing 82. At the top front of the media sensor 80, there is disposed an LED display 88 for indicating a state of an apparatus depending on whether light is turned on or off. The top surface of the lower housing 82 is a placement surface S2 on which a paper 300 to be inserted by the user is placed. At the time of measurement, the user inserts a paper 300 into a paper conveyance region 800 by a hand from an insertion slot. At this time, a paper 300 moves along an insertion direction (a Y direction) while sliding on the placement surface S2, collides with a wall S3 on a back side, and then stops.

As shown in FIG. 39A, in the media sensor 80b, in the order from the insertion skit toward the back side, a basic weight detector 500, a first media set sensor 850, a surface nature detector 600, a paper thickness detector 400, and a second media set sensor 860 are disposed. Moreover, the paper thickness detector 400 is mounted on a pressing plate 701 of the paper pressing mechanism 700 and moves with the up-and-down movement of the pressing plate 701. This pressing plate 701 presses a paper 300 at the time of measurement. Moreover, the media sensor 80b includes a processor and a memory (not shown) and controls various types of operations.

The paper thickness detector 400, the basic weight detector 500, the surface nature detector 600, and the paper pressing mechanism 700 have the respective same functions of the paper thickness detector 40, the basic weight detector 50, the surface nature detector 60, and the paper pressing mechanism 70 of the above-mentioned media sensor 80a in the apparatus. The first media set sensor 850 and the second media set sensor 860 detect the existence or nonexistence of a paper in the detection region. For example, these sensors area reflection type sensor and includes a light emitting element that irradiates light towards a detection region (below-mentioned detection region a30) and a light receiving element that receives reflected light from a paper 300. These light emitting element and light receiving element are disposed above the paper conveyance region 200 (upper housing 81).

As shown in FIG. 39B, in the media sensor 80b, in the order from an insertion slot toward the back side, there are disposed a detection region a50 of the basic weight detector 500, a detection region a85 of the first media set sensor 850, a detection region a60 of the surface nature detector 600, a detection region a40 of the paper thickness detector 400, and a detection region a86 of the second media set sensor 860.

Since the basic weight detector 500 and the surface nature detector 600 are the same as the basic weight detector 50 and the surface nature detector 60 of the media sensor 80a, respectively, the description for them is omitted. Although the paper pressing mechanism 700 and the paper thickness detector 400 are the same in terms of function as the paper pressing mechanism 70 and the paper thickness detector 40 of the media sensor 80a, they are different in a point of using a contact portion 402 without using rollers (roller pair 41) as follows.

The pressing region a70 corresponds to the pressing surface of the pressing plate 701 of the paper pressing mechanism 700. The pressing plate 701 is provided with an opening portion correspondingly to the detection region a40, and at the inner side of the opening portion, the contact portion 402 of the paper thickness detector 400 is disposed. The contact portion 402 swings within a predetermined range and is urged upward (toward the bottom surface S1). In a state where the pressing plate 701 is lifted up toward the bottom surface S1 of the upper housing 81, the height of the contact portion 402 is detected by a height position sensor at a time when then exists a paper 300 and at a time when them does not exist a paper 300, the thickness of the paper 300 is detected on the basis of a difference (μm) between both heights.

When the first media set sensor 850 on a front side becomes ON (a paper exists), the processor of the media sensor 80b starts measurement of the paper physical properties by the basic weight detector 500. Successively, when the second media set sensor 860 on a back side becomes ON, the processor of the media sensor 80b determines that a paper 300 has been set and performs measurement of the paper physical properties by the paper thickness detector 400 and the surface nature detector 600 while holding the paper 300 by the lifted-up pressing plate 701 of the paper pressing mechanism 70. Then, after measurement has been completed, the pressing plate 701 is lowered, the paper 300 is made free, and measurement of various paper physical properties is ended. In this connection, in place of the mechanism of the paper pressing mechanism 70, it may be permissible to configure such that by operating a lever manually by a user, the press plate 701 is moved upward and downward. In this case, while lifting up and pressing a paper 300, the paper physical properties are measured by the paper thickness detector 400 and the surface nature detector 600.

The configuration, described in the above, of the converting device 30, the media sensor 80, and the image forming apparatus 10 has been merely used to describe a main configuration in order to describe the features of the above-described embodiments. Accordingly, without being limited to the above configuration, various modification can be made within the scope of claims. Moreover, it is not intended to exclude a configuration equipped in a general converting device, image forming apparatus, and media sensor.

Devices and methods to perform various types of processing in the converting device 30 according to the embodiments mentioned above can be realized by any one of a hardware circuit for exclusive use and a programmed computer. The above-described program, for example, may be provided by a computer-readable recording medium, such as a USB memory and DVD (Digital Versatile Disc)-ROM, or may be provided on-line through a network, such as the internet. In this case, the program recorded in a computer-readable recording medium is usually transmitted to and memorized in a memory unit, such as a hard disk. Moreover, the above-mentioned program may be provided as independent application software or may be incorporated in the software of an apparatus as one function of the apparatus.

Although embodiments of the present invention have been described and illustrated in detail, the disclosed embodiments are made for purpose of illustration and example only and not limitation. The scope of the present invention should be interpreted by terms of the appended claims.

What is claimed is:

1. A converting device for use in a media detecting system that includes a first media sensor that includes one or more internal sensors and measures one or more paper physical properties of a recording medium and a second media sensor that includes one or more internal sensors and measures one or more paper physical properties of a recording medium, the converter comprising:
an acquisitor that acquires, from the first media sensor, first detection data constituted by a measurement result of one or more paper physical properties obtained by measuring a recording medium;
a converter that converts the acquired first detection data into conversion data being information on a basis of a measurement result of the second media sensor; and
an output unit that outputs the conversion data converted by the converter.

2. The converting device according to claim 1, wherein the conversion data being information on a basis of a measurement result of the second media sensor is at least one of a conversion value used as a sensor output of the internal sensor of the second media sensor, data that is calculated on a basis of the conversion value and is used for setting a control parameter of an image forming apparatus, and the control parameter.

3. The converting device according to claim 2, wherein at a time of forming an image on the recording medium whose paper physical properties have been measured, the image forming apparatus controls image formation and/or conveyance of a recording medium and/or post processing by using a control parameter set on a basis of the conversion data.

4. The converting device according to claim 1, wherein the acquisitor acquires the first detection data,
directly from the first media sensor,
from an image forming apparatus operating in cooperation with the first media sensor, or
from an information processing device operating in cooperation with the first media sensor.

5. The converting device according to claim 1, wherein the output unit outputs the conversion data to any one of
the first media sensor,
an image forming apparatus,
an information processing device, and
a portable memory device connected to the converting device.

6. The converting device according to claim 5, wherein the image forming apparatus of an output destination is an image forming apparatus cooperating with any one of the first and second media sensors.

7. The converting device according to claim 1, wherein the first and second media sensors are configured in at least one of
a first configuration that one of the first and second media sensors includes an internal sensor capable of measuring one or more paper physical properties incapable of being measured by other media sensor, and
a second configuration that respective internal sensors of the first and second media sensors to measure one or more same paper physical properties are different in one of detection accuracy and detection characteristics from each other.

8. The converting device according to claim 1, wherein among a plurality of the internal sensors of each of the first and second media sensors to measure common paper physical properties, some of the internal sensors have common performance and some of the internal sensors have uncommon performance, and
the converter converts only a measurement result of a paper physical property having been measured by the internal sensor having the uncommon performance into the conversion data.

9. The converting device according to claim 1, wherein the converting device is mounted on any one of the first and second media sensors, an image forming apparatus, and an information processing device.

10. The converting device according to claim 9, wherein the image forming apparatus on which the converting device is mounted is an image forming apparatus cooperating with one of the first and second media sensors.

11. The converting device according to claim 1, further comprising: with regard to identification information on each of the first and second media sensors and an image forming apparatus that controls image formation and/or conveyance of a recording medium and/or postprocessing by using a control parameter set on a basis of the conversion data at a time of forming an image on the recording medium whose paper physical properties have been measured,
a memory that memorizes a configuration table that associates the identification information with a configuration of the first and second media sensors and the image forming apparatus,
wherein the acquisitor acquires the identification information from each of the first and second media sensors and the image forming apparatus, and
the converter refers to the acquired identification information and the configuration table at a time of converting the first detection data to the conversion data.

12. The converting device according to claim 11, wherein in a case where, at a time of acquiring the identification information from each of the first and second media sensors and the image forming apparatus, information with regard to any one of the identification information does not exist in the configuration table,
the configuration table in the memory is updated with a new configuration table acquired from a server connected to a network.

13. The converting device according to claim 1, wherein the media detecting system further includes a third media sensor that includes one or more internal sensors and measures one or more physical properties of a recording medium, and
the converter acquires designation information of conversion data and converts, on a basis of the designation information, the acquired first detection data into any one of conversion data being information on a basis of a measurement result of the second media sensor and conversion data being information on a basis of a measurement result of the third media sensor.

14. The converting device according to claim 1, wherein the converter converts the first detection data, on a basis of a function of an image forming apparatus that uses conversion data, into any one of conversion data being information on a basis of a measurement result of the second media sensor and second conversion data being information on a basis of a measurement result of a third media sensor, and
the image forming apparatus controls, by using one of the converted conversion data and the second conversion data, image formation and/or conveyance of a recording medium and/or postprocessing.

15. A media detecting system, comprising:
a first media sensor;
a second media sensor;
an image forming apparatus; and
the converting device according to claim 1.

16. An image forming apparatus, comprising:
the converting device according to claim 1;
a conveyor that conveys a recording medium;
an image former that forms an image onto the conveyed recording medium; and
a processor,
wherein at a time of forming an image ono the recording medium whose physical properties have been measured by a first media sensor or a second media sensor, the processor controls, by using a control parameter set on a basis of the conversion data, image formation by the image former and/or conveyance of a recording medium by the conveyer and/or postprocessing.

17. A computer-readable recording medium storing a control program to control a converting device for use in a media detecting system that include a first media sensor that includes one or more internal sensors and measures one or more paper physical properties of a recording medium and a second media sensor that includes one or more internal sensors and measures one or more paper physical properties of a recording medium, the control program adapted to make a computer to execute processing, the processing comprising:
(a) acquiring, from the first media sensor, first detection data constituted by a measurement result of one or more paper physical properties obtained by measuring a recording medium;
(b) converting the first detection data acquired in (a) into conversion data being information on a basis of a measurement result of the second media sensor; and
(c) outputs conversion data converted in (b).
